(19) United States
(12) Patent Application Publication
(10) Pub. No.: US 2008/0278314 A1
(43) Pub. Date: Nov. 13, 2008

(54) EVENT TRACKING AND MONITORING SYSTEM

(75) Inventors: Jerry E. Miller, Traverse City, MI (US); Randall L. Perrin, Grawn, MI (US); James D. Anderson, Kingsley, MI (US); Jabin D. Reinhold, Traverse City, MI (US); Douglas W. Spencer, Williamsburg, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: IonEarth LLC, Traverse City, MI (US)

(21) Appl. No.: 12/111,422

(22) Filed: Apr. 29, 2008

Related U.S. Application Data
(60) Provisional application No. 60/914,887, filed on Apr. 30, 2007.
(60) Provisional application No. 60/983,609, filed on Oct. 30, 2007.

(51) Int. Cl. G08B 1/08; G07C 1/22

(52) U.S. Cl. 340/539.13; 340/323 R

(57) ABSTRACT

A race tracking and monitoring system using satellite communications may support racing teams in remote areas, and may provide information to officials, media broadcasters, or other interested parties while minimizing the cost of communications. The system may include a race vehicle communication device, a satellite network, check point communication devices at check points along a race route, and a control. The race vehicle communication device generates outputs, including the geographical location of the race vehicle, to the satellite network, and receives inputs from the satellite network. The check point communication device generates an output to the satellite network, including data indicative of the race vehicle passing a given check point. The control receives the outputs of the race vehicle communication device and the check point communication device via the satellite and processes the outputs, and generates a control output responsive to the processing.

### CROSS-REFERENCE TO RELATED APPLICATION

The present invention claims the benefit of U.S. provisional application Ser. No. 60/914,887, filed Apr. 30, 2007, and U.S. provisional application Ser. No. 60/983,609, filed Oct. 30, 2007, which are hereby incorporated herein by reference in their entireties.

### FIELD OF THE INVENTION

The present invention relates generally to tracking systems, and, more particularly, to tracking systems for one or more vehicles taking part in an event, such as a race.

### BACKGROUND OF THE INVENTION

Races or other events that take place in remote settings, such as in deserts, undeveloped terrain, lakes, oceans, in the air, or the like are typically hindered by a total or partial lack of data communication coverage. Thus, race crews and support crews are often unable to effectively communicate their locations or other helpful information to one another, to race officials, to the media, or to fans or supporters or other interested parties. This lack of information may affect race or event progress, safety, fairness and/or supervision, and the entertainment value of the event, for example.

### SUMMARY OF THE INVENTION

The present invention provides an event or object monitoring and tracking system that is operable to track and/or monitor the geographic location and/or status of vehicles or objects and to communicate information to the vehicle or objects via a communication satellite network. The system of the present invention is particularly suited for events where the objects or vehicles are in a location where cell phones or radios may not provide adequate communication, such as in off-road or desert racing events or sailboat races or dog sled races or other events that involve travel in remote or isolated areas around the globe. The system of the present invention receives geographic location data from the individuals or vehicles being tracked, such as a race vehicle and one or more chase vehicles, and may communicate appropriate data or information back to each of the vehicles or objects via the satellite network.

According to an aspect of the present invention, an event tracking system for tracking and monitoring multiple objects of an event includes a first communication device and a first display device of a tracked object, a second communication device and a second display device of a second object or tracking object, and a control or server or processor.

The first communication device generates a first output to a satellite network and receives an input from the satellite network. The first output includes data indicative of a geographical location of the first or tracked object (such as obtained via a GPS system of the tracked object). The first display device is operable to display information indicative of the geographical location of the first object. The second communication device is operable to generate a second output to the satellite network and to receive an input from the satellite network. The second output includes data indicative of the geographical location of the second object. The second display device is operable to display information indicative of the geographical location of the second object. The control is operable to receive the first and second outputs of the communication devices via the satellite network and to process the first and second outputs. The control is operable to generate a control output responsive to the processing. The control output communicates data indicative of the geographical location of the first object to the second communication device of the second object. The second display device is operable to display information indicative of the geographical location of the first object in response to the second communication device receiving the control output.

The first communication device is responsive to the control output and may be operable to adjust information being displayed by the first display device in response to the control output. The control output received by the first communication device may include different information or data than the control output that is received by the second communication device, so that the first display device may display different information than the second display device in response to the control output or outputs. For example, the first communication device may be responsive to the control output such that the first communication device is operable to adjust information being communicated by the first communication device in response to said control output. Optionally, the first communication device may be operable to adjust information being displayed by the first display device in response to the control output.

In one form, the event comprises a vehicle race, where the tracked object comprises a race vehicle and the tracking object comprises at least one chase vehicle. In another form, the event may comprise an individual tracking event, with the tracked object comprising at least one tracked individual or vehicle and the tracking object comprising at least one other individual or vehicle, such as a rescue team vehicle or member.

In another aspect of the present invention, the system may be used to track competitors in long-distance races. One such application could be long-distance sailing races where competitors are often out of sight of each other for prolonged periods of time during the race. Providing the position, course, and speed of sailboats in an extended race to the captains of the race boats may provide all captains meaningful information from which they can make informed tactical and strategic decisions during the race.

In still another aspect of the present invention, the system may be used by racing organizations to monitor races and confirm that all competitors have properly negotiated the entire course; to provide split times and other race statistics; to provide content for entertainment media outlets; and to provide safety measures during a racing event.

The system of the present invention receives geographic location data from the vehicles being tracked, such as a race vehicle and one or more chase vehicles, and may communicate appropriate data or information back to each of the vehicles or objects via the satellite network.

Although suitable for tracking race vehicles in a race, other applications of the tracking system may be implemented, such as a person-to-person activity (such as two or more hunters or explorers or the like), recreational vehicle tracking on the internet (such as tracking a person's RV or boat or the like during a vacation or trip or expedition), offshore boat deliveries, ballooning (such as for tracking with a balloon recovery vehicle), “smart” life jackets/lifeboats, adventure travelers, expeditions (such as wilderness or sea expeditions, such as Canada's NWT to Beaufort Sea), disaster workers, smokejumpers (who could have the advancing fire front relayed to them from satellite imaging and overlaid on a 3-D terrain map on their display unit, along with co-workers), and/or the like, while remaining within the spirit and scope of the present invention.

The second output of the second communication device may include a waypoint or geographical coordinate as input by the second object or a person or user associated with the second object. The waypoint is received by the control and is communicated to the first communication device of the first object, whereby the waypoint is displayed on the first display device of the first object. A rendezvous point or waypoint thus may be communicated from a second or tracking object, such as a chase vehicle or the like, to the first or tracked object, such as a race vehicle or the like, whereby the tracked object receives positional information relating to where to meet the tracking object, such as for refueling or repairs or rescue or the like.

Optionally, the tracking system of the present invention may provide an internet “viewing” capability of the system, whereby a user (such as a member of the general public or an authorized user) of the system may access a website and view the tracked objects online. Optionally, the tracking system of the present invention may provide viewing of multiple targets or objects on a display or screen or monitor, such as multiple vehicles that are part of a race team, whereby the viewer can track and monitor more than just the race vehicle during the race.

Optionally, the system is configurable to arrange multiple tracked objects into a “team view” or multiple team views. The concept of team views can be extended to any class, category, or functional group that may benefit from displaying the group separate from other such groups. Furthermore, the system provides Internet viewing of an event for anyone with an Internet connection and a computer and an Internet browser.

These and other objects, advantages, purposes and features of the present invention will become apparent upon the view of the following specification in conjunction with the drawings.

### BRIEF DESCRIPTION OF THE DRAWINGS

FIG. 1 is a schematic of a monitoring and tracking system in accordance with the present invention, shown for tracking a race vehicle, such as for an off-road race or event;

FIG. 2 is a sample display view of the system of the present invention, showing the entire team on the display;

FIG. 3 is another sample display view of the system of the present invention, showing only part of the team shown in the display of FIG. 2;

FIG. 4 is another sample display view of the system of the present invention, showing the remainder of the team shown in the display of FIG. 2;

FIG. 5 is another sample display view of the system of the present invention, showing the location and data associated with a vehicle of the team shown in the display of FIG. 2;

FIG. 6 is a communications protocol useful with the monitoring and tracking system of the present invention;

FIG. 7 is a communications pathway suitable for the monitoring and tracking system of the present invention;

FIG. 8 is a schematic of a packet collation function of the monitoring and tracking system of the present invention;

FIG. 9 is a flow chart of the communications pathway for the monitoring and tracking system of the present invention;

FIG. 10 is a block diagram of an SRT unit of the monitoring and tracking system of the present invention; and

FIG. 11 is a sample display view of a map showing tracked objects or vehicles in accordance with the monitoring and tracking system of the present invention.

FIG. 12 is a schematic of a monitoring and tracking system in accordance with the present invention, shown for tracking a sailing vessel, such as for a sailing race or event;

FIG. 13 is a diagram depicting a point-to-point course for a sailing race;

FIG. 14 is a diagram depicting a closed-loop course for a sailing race;

FIG. 15 is a diagram of a one-dimensional check point;

FIG. 16 is three diagrams of exemplary two-dimensional check points;

FIG. 17 is two diagrams of exemplary three-dimensional check points;

FIG. 18 shows concentric rings depicting the distance to the first check point in a race, overlaid on the point-to-point course diagram of FIG. 13;

FIG. 19 shows concentric rings depicting the distance to the first two check points in the point-to-point course of FIG. 13;

FIG. 20 shows concentric rings depicting the distance for four check points in the point-to-point course of FIG. 13;

FIG. 21 is a map of a remote race course with check points along the course, such as at highway crossings;

FIG. 22 is a map of the remote race course of FIG. 21 with automatic check points at ten mile intervals in addition to check points at highway crossings;

FIG. 23 is a table showing overall results for a racing event following the remote race course of FIG. 21;

FIG. 24 is a table showing total elapsed time at each of four check points for a racing event following the remote race course of FIG. 21;

FIG. 25 is a table showing various elapsed times recorded at a single check point for a racing event following the remote race course of FIG. 21;

FIG. 26 is a table showing individual segment results for one racer following the remote race course of FIG. 21;

FIG. 27 is a table showing one racer's segment results between each automatic check point along the remote race course of FIG. 22;

FIG. 28 is a table showing average speeds for racers between each automatic check point along the remote race course of FIG. 22;

FIG. 29 is a table showing average speeds for racers between each check point along the remote race course of FIG. 22;

FIG. 30 is a graph of the average speeds of racers along segments between each of four highway crossing check points of FIG. 21; and

FIG. 31 is a graph of the average speeds of FIG. 29.

### DESCRIPTION OF THE PREFERRED EMBODIMENTS

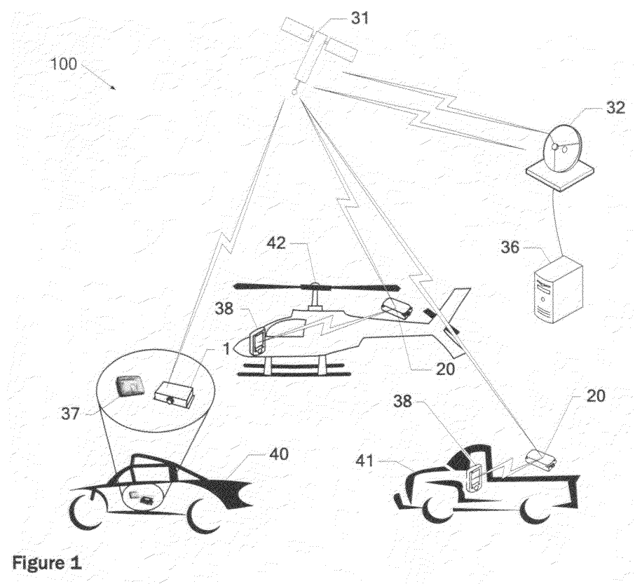

Referring now to the drawings and the illustrative embodiments depicted therein, an event or object monitoring and tracking system or satellite race telemetry (SRT) system 100 is operable to track and/or monitor the location (and optionally movement and/or performance data and/or vehicle status data and/or biometric data and the like) of two or more vehicles or objects or individuals taking part in an event, such as a race or the like. In the illustrated embodiment of FIG. 1, SRT system 100 is implemented to track and/or monitor an off-road type vehicle race, whereby SRT system 100 tracks a race vehicle 40 and one or more chase vehicles 41 and/or one or more chase helicopters 42 via a communications satellite or satellite network 31. The SRT system 100 is operable to track the geographic location and optionally vehicle status information of the race vehicle 40 and may communicate the race vehicle's location information and/or status information to one or more of the chase vehicles 41, 42 so that the chase vehicles may rendezvous with the chase vehicle during the off-road race, as discussed below. Although shown and described as being implemented for an off-road race team, it is envisioned that aspects of the present invention may be utilized in various events or team events or activities where it is desired to track and monitor one or more objects or vehicles or individuals and where it is desired to provide information about one or more of the tracked objects or vehicles or individuals to another object or vehicle, as also discussed below.

By utilizing a satellite network and global positioning system, the SRT system 100 provides communications and telemetry information or data (such as vehicle status and position information) between race vehicles and support/chase vehicles regardless of the geographic location of the vehicles. While some known systems provide geographic positional data for “online” viewing or tracking, the system of the present invention is a globalized system that provides a bi-directional communications structure to return geo-positional data to units in the field where no Internet access is available. Known systems that provide positional data are limited to either sharing positional data across limited distances governed by the range of short range radio transceivers, or, such as in the case of global systems, the transfer of positional data is strictly a unidirectional flow of information to a base or monitoring center, and does not provide or communicate the geo-positional information to the units in the field. Although some of these monitoring centers may have bi-directional communications, they do not provide automatic and periodic reporting of positional information to units in the field. Furthermore, these systems do not have the capability of sharing information with a plurality of units in the field.

Many distance racing venues are located in areas that have no ground-based communications infrastructure, such as cellular telephone towers or radio repeaters, to handle communications between race team members. Typically, radio frequency communication devices or radios are only useful for a range of about 50 miles or less. Mountains and other rugged terrain impose further limits on the effectiveness of two-way radio communications. The event monitoring or satellite race telemetry (SRT) system of the present invention overcomes these communication barn ers by relying on low earth orbit (LEO) satellites, satellite transceivers, and global positioning system (GPS) receivers. By sending this data through the satellites, satellite gateway, and the Internet, the satellite race telemetry system of the present invention allows global race tracking from anywhere to anywhere, regardless of geographical location and terrain and the like. The tracked vehicles or assets can be located anywhere and the race telemetry data is accessible from anywhere, and neither the tracked vehicle nor the monitoring station or base requires any direct terrestrial connection to one another. Optionally, the SRT system of the present invention may also make race telemetry information available to any computer that has an Internet connection, such that the race fans or news media may access and observe the race vehicle's position and other transmitted data in a real time or substantially real time manner. Optionally, the satellite network or system may include communication or connection to the world wide web, or may be part of a TCP/IP network or the like. In such an embodiment, the system may include one or more sensors as part of the network. Optionally, the SRT system of the present invention may use medium-distance communication protocols, such as wi-fi or wi-max or the like, in place of or in addition to satellite communications, depending on the particular application of the SRT system.

In the illustrated embodiment, the SRT system of the present invention is shown for supporting race teams in remote areas that lack communications infrastructure (such as off-road race teams or desert race teams or sailboat race teams or the like). However, the SRT system may be readily applied to other events or activities to track positional information and provide two-way communications, for any mobile assets anywhere. For example, a few of the envisioned system applications include, but are not limited to: off-road racing events and teams, boat racing events and teams, air racing events and teams, offshore boat deliveries, “smart” lifejackets/lifeboats, adventure travelers, expeditions, disaster workers, smokejumpers, search and/or rescue teams (such as for tracking and communicating with fire fighters in forest fires and the like), dog sled racing events and teams, hot air ballooning (with ground support/chase crews), wilderness adventurers or any other situation where units or objects or vehicles or people or the like in the field need to know the whereabouts of other field assets or objects or vehicles or people or the like. The SRT system is readily provided for various objects or vehicles or individuals, where each person or vehicle or object may carry or include a satellite race telemetry device (SRT, or just “tracker”), a display device and a power source or supply to power them both. SRT system 100 is shown as used for off-road or desert racing teams. Desert racing vehicles travel in very remote areas for long distances where traditional communications infrastructure is sparse to non-existent. Racing vehicles need to communicate with support vehicles and support vehicles need to know where to bring fuel, spare tires, and replacement parts. The lack of communications equipment often presents logistical concerns or problems. SRT system 100 solves some of these problems by providing a way for support vehicle occupants to know where the race vehicle is at all times and for the race vehicle occupants to know where to meet support vehicles to get fuel and other supplies. The SRT system thus may provide information to the race vehicle or tracked vehicle that informs the racer of the racer's current geographical location and/or the geographical location of other racers or checkpoints or chase vehicles or the like. In some situations, the information provided by the SRT system to the racer may be reduced or limited (such as for dog sled races, where the race organizers may not want the racers to have GPS-derived position data for themselves or for their fellow competitors on the course), while remaining within the spirit and scope of the present invention.

Optionally, the tracking system of the present invention may allow two-way text communication between the race vehicles and support vehicles. For such an application, a personal digital assistant (PDA) or display device 38 may be used as an input device for inputting the text messages for the chase vehicles, or optionally, it is envisioned that the SRT system 100 may include a keyboard input (such as a socket or port or USB port for plugging in a keyboard or keypad or a wireless communication link for receiving a signal from a wireless keyboard or keypad or the like), such that the user may key in or type in or otherwise compose the text message via the keyboard or keypad. Optionally, the SRT system may include a microphone or voice receiver and/or voice recognition function and the user may provide the input via a voice message, whereby a receiver or microphone of the SRT system may receive the voice message and the system may recognize and transcribe the voice message into a text message for communicating to the base or other vehicles or, optionally, the base or the SRT of the other vehicles may provide an audio output (such as via a speaker) to audibly communicate the audio or voice message to the user or users at the base or other vehicles. The message or messages may be sent to a particular vehicle (such as to the race vehicle or to a particular chase vehicle as may be identified in the message or communication) or may be sent to a particular group of vehicles (such as the chase vehicles associated with a particular race vehicle or chase vehicles that are near or nearer to the race vehicle or the like). The race vehicle SRT may be configured to ignore all text messages except those sent directly to or addressed to the race vehicle, in order to reduce the potential distraction to the driver of the race vehicle.

With reference to FIG. 1, a typical race team will have at least one race vehicle 40. To support the race vehicle 40, a team usually has one or more chase vehicles 41, and sometimes several chase vehicles, and sometimes even one or more helicopters 42. The chase vehicles 41 bring fuel and other supplies for the race vehicle 40 to points along the race course. Some of these points are official pit stops or check points set up by the race or event, while others may be where the race course crosses a road or trail. In desert racing, such pit stops or areas are often not well defined. The chase vehicle or vehicles 41 follow established roads where possible and must often use unimproved roads, or trails, to reach a pit area. Often, a chase vehicle crew will have to make a quick decision about where to intercept the race vehicle, which is not easily done when the race vehicle's location on the course is unknown. Thus, knowledge of the location of the race vehicle is a great benefit to the chase vehicle crew. Generally, helicopters 42 are not permitted to provide support, but teams are permitted to use them as an observation platform from which to watch the race.

SRT system 100 thus includes a race vehicle satellite race telemetry (SRT) or tracking device or tracker 1 that is mounted at or on or in the race vehicle 40, one or more chase vehicle SRTs or tracking devices or trackers 20 mounted at or on or in one or more chase vehicles 41, and a central monitoring station (CMS) or server or servers 36 for receiving information data from the chase and race vehicle SRTs and controlling communication of data to the chase and race vehicles via a satellite gateway 32 and the satellite network 31 and the SRTs 1 and 20. The server or group of servers 36 thus may process the information going back and forth between SRTs. To connect everything together, the SRTs and servers communicate by way of the satellite network and the Internet, as discussed in detail below.

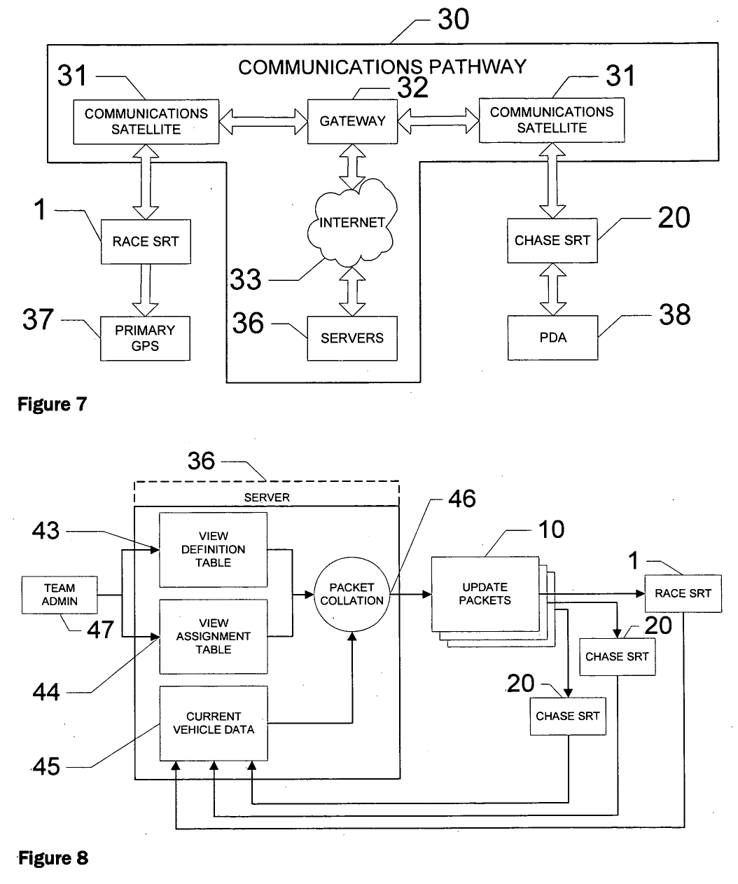

Every communication to or from an SRT thus travels through a communications pathway 30 (FIG. 7). The SRT system is a two-way communications system for tracking vehicles in remote areas. The system relies on vehicle-based telemetry units as well as computer servers connected to the Internet. To connect these entities, the SRT system uses satellite communications and the Internet, as discussed below.

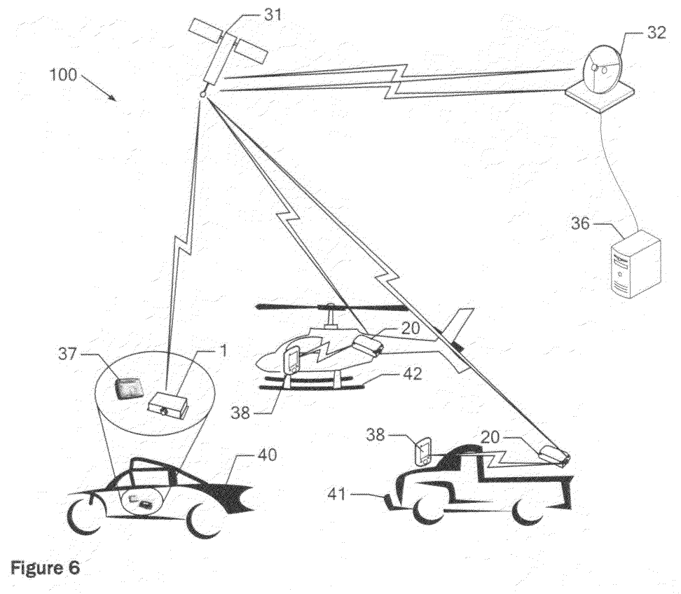

With reference to FIG. 6, information data flows or is communicated or streamed from the SRT 1 of the race vehicle 40 to the satellite constellation 31 to the satellite gateway 22 to the server or servers 36 that process the information. The servers 36 process the data and disseminate the information data through the satellite gateway 22 and the satellite constellation 31 to the communication devices or SRTs of the race team vehicles, including the race vehicle 40 and the chase vehicles or support vehicles 41 and/or 42. Generally speaking, the race vehicle SRT 1 tracks its own position and sends that information by way of the satellite 31 to the server 36, which in turn sends the information out to the team's chase vehicle SRTs 20. Optionally, the race SRTs 1 may also be capable of sending text messages through the server 36 to the other SRTs 20, such as in a manner as discussed below.

There are three typical paths that information follows as it flows through the system: (i) from the race SRT 1 to a chase SRT 20; (ii) from a chase SRT 20 to a race SRT 1; and (iii) from one chase SRT 20 to another chase SRT 20. To illustrate the first flow, and with reference to FIGS. 6 and 7, the sequence begins at the race vehicle SRT 1 and is transmitted from the race SRT 1 to the communications satellite 31, through the satellite gateway 32, to the Internet 33, and to the servers 36. The servers process and collate the data into individual packets (discussed below) for each receiving SRT 1 or 20. The information goes from the servers 36, back through the Internet 33, to the satellite gateway 32, to the communications satellite 31, and then back down to the receiving chase vehicle SRT 20, where the information may be displayed on the display device or PDA 38 of the chase vehicle 41 or 42.

### SRT Units

Each vehicle 40, 41, 42 includes or carries an SRT unit, which, in the illustrated embodiment, has a GPS receiver, a satellite modem, and a BLUETOOTH® transceiver (or wi-fi or other short or medium range radio frequency communication protocol or the like) for communicating with a display device of the respective vehicle. The display device 38 can be a laptop computer, tablet computer, PDA (personal digital assistant) or any other device capable of displaying a map and/or other suitable information, and includes an interface or input. Optionally, the display device may be part of the communication device, whereby a short range communication protocol or unit need not be included. The SRT unit 1, 20 of the SRT system 100 provides the following functions: (i) it keeps track of its own geographical location, (ii) it acts as a two-way communications device, and (iii) it keeps track of the other team vehicles' locations.

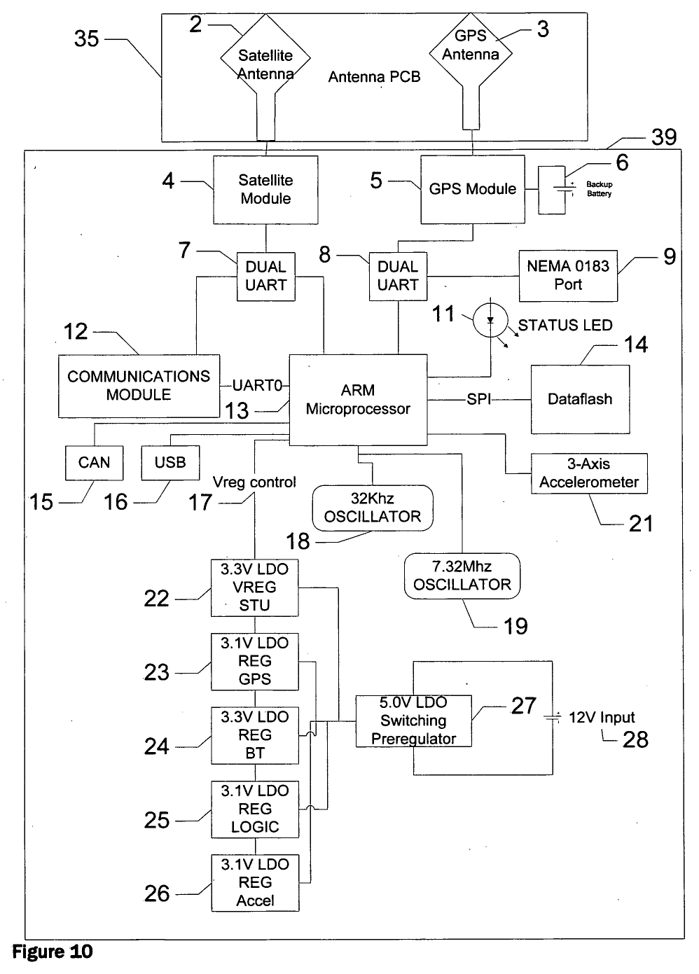

As shown in FIG. 10, the SRT unit may include one or more circuit elements, such as printed circuit boards or elements or substrates with circuitry established thereon, such as two stacked printed circuit boards or the like. The circuit boards or elements are mounted at or in and substantially encased in a housing or casing, which preferably includes a mounting structure or element for attaching or mounting or securing the housing and the SRT to the respective race or chase vehicle. In the illustrated embodiment, the SRT 1, 20 includes an antenna printed circuit board 35 that is stacked on an SRT printed circuit board 39. Antenna printed circuit board 35 includes a satellite antenna 2 and a GPS antenna 3. Satellite antenna 2 is electrically connected to or in electrical communication with a satellite module 4 of SRT circuit board 39, while GPS antenna 3 is electrically connected to or in electrical communication with a GPS module 5 of SRT circuit board 39. The satellite module 4 and GPS module 5 are each electrically connected to a respective dual universal asynchronous receiver/transmitter (UART) 7, 8 for connecting the modules to a microprocessor or control circuit 13 of the SRT.

Microprocessor 13 is operable to receive information data from satellite module 4 and GPS module 5, and may generate a control output in response to the received or input information data. The control output may be communicated to the satellite module 4 for communicating (via satellite 31) to the server 36 and/or other vehicles of the race team, as discussed in detail below. Microprocessor 13 is also connected to a BLUETOOTH® module 12 (or wi-fi module or other suitable short or medium range communication module), or may be wired directly to the display device, to communicate information signals or data to the display device 38 of the vehicle (such as either a GPS display of the vehicle or a PDA or other suitable display device associated with the respective SRT). The BLUETOOTH® module 12 may receive the control output of microprocessor 13 or may receive an input from satellite module 4, whereby BLUETOOTH® module 12 communicates the input information or data to the display device 38, as also discussed below. Optionally, a wi-fi module or other short or medium range radio frequency communication protocol or the like may be used to permit the broadcasting or sending of data from the SRT unit to one or more receivers within a limited distance. The wi-fi module or other short or medium range protocol may be more compatible with other common receivers, such as portable computers, PDA's, and wireless telephones, or units providing multiple functions, including wireless communication. Optionally, the communication link between the components may comprise a hard-wired or direct wire connection, such as a wired link between the microprocessor and the display device, while remaining within the spirit and scope of the present invention.

Microprocessor 13 may also be connected to or in communication with a vehicle communications network or bus 15 of the vehicle, such as a controller area network (CAN) or other suitable vehicle network (such as a local interconnect network (LIN) or a FlexRay network or the like). Such a connection provides an input to microprocessor 13 from a vehicle system, such as for providing information data relating to the status of one or more vehicle systems, such as an engine control module or a tire pressure monitoring system or a climate control system or a temperature system or the like, such that vehicle status information data may be communicated (via microprocessor 13 and satellite module 4 and satellite antenna 2 and satellite 31) to the server or servers 36. Microprocessor 13 may also receive an input from an accelerometer 21, such as a three-axis accelerometer, such as for detecting the tilt or pitch of the vehicle and/or accelerations in multiple directions that the vehicle encounters during the race.

Microprocessor 13 may also be connected to or in communication with a USB port 16 (or other suitable external port or connection) of the SRT to receive an input from a device connected to or plugged into the USB port. Also, microprocessor 13 may be associated with a data storage device 14 so that the microprocessor may store data and/or may access or retrieve stored data. The microprocessor 13 and SRT are connected to a power input 28 for connecting to a vehicle power source, such as the vehicle battery. In the illustrated embodiment, the power input 28 is connected to a switching pre-regulator 27, which in turn is connected to the voltage regulators 22-26 of the voltage regulator control 17. Optionally, a status indicator or light 11, such as a light emitting diode (LED) or the like, may provide a visible indication of the operability or on/off status of the SRT 1, 20.

The race vehicle SRT 1 and the chase vehicle SRT 20 are two-way communications devices for collecting position information along with race telemetry and sending the information through the satellite network 31 to the servers 36. The SRTs 1, 20 are capable of determining their geographical location on the face of the earth, collecting vehicle telemetry data, and handling two-way communications from anywhere on the planet. The SRTs of the race vehicle 40 and of the chase vehicles 41, 42 may be substantially similar to one another, or may have different features for their particular application, such as those discussed below.

For example, the race vehicle SRT unit 1 (FIG. 10) may include the external GPS antenna 3 and the external satellite transceiver antenna 2, but, although the SRT 1 contains a GPS receiver, it may not have to replace the race vehicle's primary GPS unit. Instead, the race vehicle SRT 1 may work with the vehicle's GPS receiver and display monitor. For example, the race vehicle SRT 1 may have a NMEA 0183 serial bus communications port 9 that is configured to link to the vehicle's primary GPS unit. This connection facilitates the transfer of waypoint data from the SRT unit to the race vehicle's GPS display, which allows chase vehicles the option of designating an impromptu waypoint as a contingency stop, as discussed below.

The race vehicle SRT unit 1 may be slightly larger and more rugged than the chase vehicle units 20. For example, the larger size may be due to: (i) increased external connections (external antennas, automotive CAN bus connections, and connection to the vehicle's primary GPS display); (ii) internal back-up batteries (in case the vehicle's electrical system fails); (iii) the need for additional flexibility during installation; and/or (iv) extra built-in durability for harsh conditions and rough rides.

The race vehicle SRT unit 1 may be operable to provide the following functions or characteristics: (i) send race vehicle telemetry to chase vehicles 41, 42 (ground based and airborne) by way of satellite 31, where such vehicle telemetry may include the location, heading, speed, and/or attitude/orientation and/or the like and (ii) receive rendezvous (pit stop) waypoints from chase vehicles. The waypoints preferably include GPS coordinates and the chase vehicle ID. The purpose of this feature is to allow the race vehicle 40 to navigate directly to the chase vehicle's pit location. The race vehicle driver thus can stay on the throttle, and the navigator can be confident of where he or she is going. This reduces the confusion of guiding a race vehicle to a pit area at night, for example. Pit areas may be crowded with dozens or even hundreds of support, spectator, and race vehicles. The race vehicle SRT 1 may be packaged in a sealed enclosure and can be mounted anywhere at or on or in the vehicle 40. Two small aerospace-grade antennas may be mounted on the roof of the race vehicle, such as under a fiberglass roof panel or the like, and coaxial cables or the like may connect the antennas to the SRT. The SRT 1 may be powered by the race vehicle's electrical system. An internal backup battery is preferably provided to power the SRT 1 for several hours if the race vehicle's power system fails (thus, the system may be kept running even if the race vehicle's electrical system is shut down). The SRT unit 1 may be programmable by way of the BLUETOOTH® device or wi-fi device or link or module 12 (wireless connection to the PC 34). The SRT unit 1 may provide a connection to the automotive CAN bus to allow for monitoring of vehicle systems and functions. The SRT unit 1 may also provide a USB connection 16 for data transfer.

The chase vehicle SRT 20, sometimes called a tracker, may be substantially similar to and may be nearly identical to the race vehicle SRT 1, discussed above. Optionally, the chase SRT 20 may be sealed in a smaller case and the chase vehicle SRT 20 may not send as much telemetry data to the rest of the team as does the race vehicle SRT 1. The chase vehicle 41 includes the SRT unit 20 and a display device 38, such as a handheld computer/PDA (Personal Digital Assistant) or the like with mapping software. The chase vehicle SRT 20 contains a satellite transceiver, GPS receiver, internal GPS and satellite antennas, and BLUETOOTH® or wi-fi communications chip or module, such as described above. The BLUETOOTH® or wi-fi chip or module handles communications between the chase vehicle SRT 20 and the chase vehicle display device 38.

The chase vehicle SRT unit 20 may be operable to display the geographical locations of the race vehicle 40, chase vehicles 41 and helicopters 42 on a handheld computer (PDA) or other suitable display device 38 in the chase vehicles 41, 42 (FIGS. 1 and 6). The display device 38 may show map data including the race course, available chase roads as provided by race organizers or that a race team has mapped themselves and/or the like. The map screen may display the race vehicle position graphically, and/or with a text screen showing the information in race miles (such as where the vehicle 40 is at along the race course) and as a direct distance and bearing to the race vehicle 40. Such race mile positioning is valuable to the chase vehicle drivers and the distance and bearing format enables helicopter pilots to fly a direct intercept route to a race vehicle 40 rather than visually following the race course until helicopter 42 catches up to race vehicle 40.

In a preferred embodiment, the SRT unit 20 for chase vehicles 41 is approximately 3 inches wide by about 6 inches long by about 1.75 inches high (although other sized units may be implemented without affecting the scope of the present invention), and may be readily mounted to the roof of the chase vehicle 41, such as with an integrated magnet mount. Similar to the race vehicle SRT 1, the chase vehicle SRT 20 may be powered via the vehicle battery supplied 12 VDC, and thus may be wired to the vehicle power supply via any suitable wiring, such as via a wire or cable that can be plugged into a cigarette lighter adapter of the chase vehicle 41. Optionally, and desirably, either or both of the SRTs 1, 20 may include a backup power supply or battery to provide operation of the SRT in situations where the vehicle battery may be dead or disconnected from the SRT.

In the illustrated embodiment, the SRT unit 20 communicates with the display device 38 by way of a BLUETOOTH® communication protocol or device or module 12 (or wi-fi or other suitable short or medium range communication protocol). All communication between the display device 38 and the SRT is preferably wireless communication, such as via BLUETOOTH®, since this allows the SRT to be mounted externally with the display device located within the vehicle cabin for viewing by the vehicle occupants. The satellite antenna 2, GPS antenna 3, and control electronics may all be contained within the SRT enclosure.

The SRT unit for other chase vehicles, such as helicopter 42, may be substantially similar to or substantially identical to the chase vehicle unit 20, but may attach with VELCRO® (or other suitable detachable attaching element or material or the like) instead of having magnets in the base (however, either SRT unit may be mounted via any suitable mounting means without affecting the scope of the present invention). The SRT box can be placed on the aircraft instrument panel. Having an SRT in the helicopter 42 allows the pilot to plot a direct course between the race vehicle 40 and fuel stops. This helps to maximize helicopter productivity while in the air, since the helicopter's personnel know the location of the race vehicle and thus the helicopter can be “on station” with the race vehicle for a longer portion of the race rather than flying around looking for the race vehicle.

The chase vehicle SRTs 20 thus may operate in a similar fashion to the race vehicle SRT 1. However, the chase vehicle SRTs 20 may have a few notable differences to provide the desired features of the system. For example, the chase vehicle SRTs 20 may communicate or stream their updated geographic position information or data less frequently than the race vehicle SRT 1. Also, the chase vehicle SRTs 20 may send waypoint information (such as a waypoint input to the chase vehicle SRT via the crew of the chase vehicle) to the race vehicle SRT 1 via the satellite network and servers. The waypoint information from the chase vehicle SRT 20 is received by the chase vehicle SRT 1 and communicated (such as via a short range communication protocol) to the race vehicle GPS display unit where the waypoint will show on the GPS display unit, thereby instructing the driver of the race vehicle to proceed to the waypoint.

Optionally, and desirably, the SRT system may receive or have 3-axis accelerometer telemetry data, such as via accelerometer 21. This will enable teams to monitor physical stresses on the race vehicle 40 and its occupants. Hard landings or roll-overs can subject the vehicle 40 and occupants to abnormal physical stress, and will be detected and/or recorded and/or monitored by the SRT units 1 and the server 36. Such information can help the race team assess the vehicle's structural condition, the safety thresholds for occupants of the vehicle, and the vehicle orientation (such as if the vehicle has undergone a rollover or is upside down). Optionally, the race vehicle SRT 1 (and optionally the chase vehicle SRTs 20 as well) may be in communication with a vehicle communication network or bus or status system, such as a vehicle diagnostics system or a vehicle tire pressure monitoring system or an engine control module or monitoring system or the like, and may communicate vehicle status information data, such as tire pressure data and engine data or the like, to the support crews (and engine builders or technicians or the like, if desired).

Optionally, and desirably, the team using the SRT system of the present invention may have the ability to quickly provision replacement units. Each satellite transceiver has a unique International Mobile Equipment Identity (IMEI) number; however, the SRT system preferably assigns a much shorter six-digit (or other size) alphanumeric ID to each SRT unit. By assigning an ID to the unit itself, instead of relying on the satellite transceiver IMEI number, the administrator or team of the SRT system can readily replace the communications chips and still establish contact with the tracking unit. This six-digit number simplifies linking the display device to the SRT unit when matching the ID to a list of ID numbers on the display device.

### Display Device

The display device 38 may comprise any suitable or known display device or monitor or screen or PDA. The functions or features or views provided by the display device may be communicated to the display device by the SRT system (such as via the BLUETOOTH® module 12 of the SRT unit). The person viewing the display device 38 may control the zoom level of the map and whether or not certain map features are visible, such as in a known manner. The display device 38 may also provide a number of calculations in order to display the course map and information about tracked vehicles. The display device may contain a keyboard for operator interaction with the device. The keyboard may be part of the display or it may be a physical keyboard.

### Servers

The SRT system 100 relies on a constellation of communications satellites 31, satellite gateway 32 to the Internet, the Internet 33, race and chase vehicle SRTs 1, 20, and several computer servers 36 to handle various communication tasks. The SRT system 100 may use one server or several servers to gather, store and disseminate information. For example, the SRT system 100 may utilize an application server, a web tracker server, an SRT system web server, and/or a database server.

The application server may prioritize and optimize the flow of information or data packets to and from the satellite gateways. To do this, the application server (i) monitors the Internet for packets from the satellite gateways; (ii) encodes and decodes data into the appropriate or desired communications format; (iii) collates data (i.e. optimizes transmission units going out to the SRTs); (iv) sends customized packets to the satellite gateways and to each chase vehicle (each vehicle's data packet may include location, heading, and speed for the race vehicle and other chase vehicles, and optionally, the data packet may not include the chase vehicle's own telemetry data); (v) applies business rules for packet content and scheduling; (vi) provides a programmable interval between packets for sending telemetry updates to the chase vehicles; (vii) configures or reconfigures the SRTs; (viii) configures or reconfigures the teams and/or views being displayed; and/or (ix) sends or communicates waypoint data from a chase vehicle to the race vehicle as needed.

To reduce the total amount of data going through the system, the SRT system provides different or appropriate “views” to the displays of the race and chase vehicles. The selectable views enable a team to configure the system so that each SRT shows what is desired at that time. For example, a chase vehicle SRT 20 and display may not need to show all the other chase vehicles 41, 42. The chase team may be primarily interested in seeing where the race vehicle is and possibly one or two other chase vehicles. The exact numbers of vehicles shown for a particular display of a vehicle are configurable for each team. Reducing the data by providing only what is desired to the particular vehicles has at least two benefits: one, it reduces the cost of operation (the system provider typically has to pay for throughput), and two, the system provider may be able to send updates more frequently. If the SRT system were to send all available information to each of the vehicles, the system could be slowed down and may not be as effective.

The web tracker server is a web server that serves both an HTML (web) page and an extensible markup language (XML) page. The web tracker server makes it possible for people to monitor the race in near real time. The HTML and XML resources allow the SRT system to display course and tracking data, such as by using Microsoft's Via Virtual Earth web site (www.viavirtualearth.com).

The web server is a separate web server that hosts the rest of the SRT system website. The web server may provide various information items via the website including, for example, news bulletins, mailing lists, team logins, and sponsor/partner logos. The website may have links and a “launch page” for the web tracker, and it may have a help page and a frequently asked questions (FAQ) page for the web tracker. Optionally, the web tracker function may be hosted by a separate server.

The database server may be any suitable server, such as, for example, a PC running Microsoft SQL Server 2005. The server stores race data and provides data to other servers and applications as needed.

Although servers 36 are described as multiple separate servers or server units, it is envisioned that more or less servers may be implemented without affecting the scope of the present invention. For example, one or more servers may be utilized to perform the desired functions, depending on the processing capability of each server.

### Data Collection Station

The system of the present invention may employ one or more data collection stations. Data collection stations provide a means of capturing information that accurately indicates the moment each vehicle arrives at a particular check point along a race course. Capturing information for each vehicle as it reaches the check point provides verification for race officials that the contestant arrived at the check point during the race. Data collection stations may be placed at the starting line, the finish line, and at check points interspersed along the course. Data collection stations may identify a vehicle or competitor as the vehicle arrives at or passes a checkpoint by any or all of three methods: (i) a type of electronic identification attached to the vehicle or competitor, such as a Radio Frequency Identification (RFID) chip or transponder or any other device capable of providing a unique vehicle identifier (which may be detected by a sensor or scanner located at the checkpoint); (ii) visual identification of the vehicle or competitor by an individual from the racing organization at the checkpoint; or (iii) the vehicle or competitor passing within a defined geographical boundary as evidenced by, or reported by, a GPS tracking device of the vehicle or competitor.

The data collection station consists of an SRT and an input device linked to the SRT. A human operator may use a handheld device to record the time each vehicle reaches the checkpoint. The handheld device transmits the information to the SRT. Optionally, in the case of a transponder-like system, the detection device determines the vehicle's ID and passes that information directly to the SRT. For GPS tracking devices, the tracking device sends a signal containing the vehicle's ID to the data collection station SRT, or the data may be transmitted directly from the tracking device to the central monitoring station (CMS) 36 via satellite 31.

The data collection SRT composes reports as vehicles pass through the check point. The information is sent via the communications pathway 30 to the CMS 36 where the information is recorded, tabulated, and distributed to the appropriate entities.

### Communications

The SRT system thus provides two-way communications between race and chase vehicles. Chase vehicle personnel can transmit a GPS waypoint to the race vehicle's GPS unit to designate a fuel/service location or other waypoint. The system also periodically transmits each vehicle's location to the other vehicles. Each of the chase vehicles can monitor the location of each of the other chase vehicles along with the location of the race vehicle. However, in order to reduce the workload for race vehicle occupants, the race vehicle SRT 1 may not receive or display locations of the chase vehicles. Rather, the race vehicle SRT 1 may be provided with waypoints for display on the race vehicle GPS display, to indicate to the race vehicle driver or crew where the next pit stop is scheduled.

By being able to communicate between race vehicles 40 and chase vehicles 41, 42, regardless of the local communications infrastructure, or lack thereof, race teams can streamline operations, move people and/or vehicles to where they need to be, and inform team members about the race vehicle's status. Communicating with team members by way of satellites 31 removes a lot of the uncertainty about how a chase crew should intercept or rendezvous with a race vehicle 40 in difficult-to-reach locations.

### Typical Race Communications

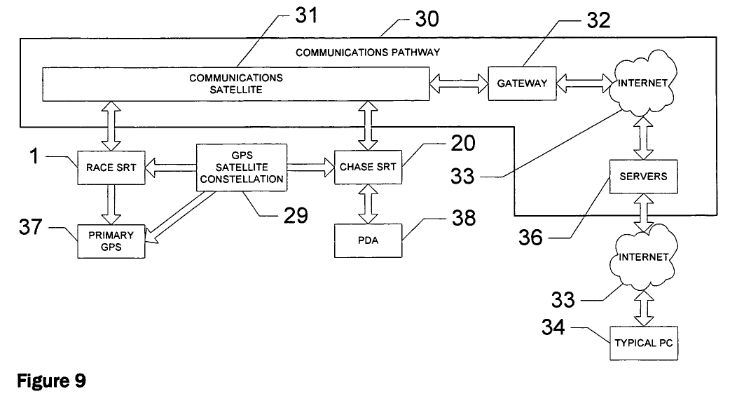

With reference to FIG. 9, the race vehicle SRT 1 (and the chase SRT 20 and the race vehicle's primary GPS) receives a GPS signal from the GPS satellite constellation 29. The race vehicle SRT 1 combines the GPS position with other race vehicle telemetry data and sends a short burst data packet to the communications satellite 31 through the satellite gateway 32 where it is sent through the Internet 33 as an e-mail message to the servers 36. The servers 36 collate information from the race vehicle SRT 1 and chase vehicle SRT 20 and send customized e-mail messages back to each SRT 1 and 20. On the return trip, the data flows backward from the servers 36, as e-mail, to the gateway 32, where it is converted to a short burst data packet and sent to the satellite constellation 31 and then down to the appropriate SRT units 1 and/or 20. Upon receiving the information packet, the chase SRT 20 forwards the GPS data of the watched or tracked vehicle (e.g., the race vehicle), such as via the BLUETOOTH® device or module 12, to the display device 38 of the chase vehicle. The display device 38 shows the location of the race vehicle SRT 1 on the map (along with any other vehicles in its view as defined by a team administrator 47).

### Special Communications

With reference to FIGS. 7 and 9, the SRT system performs several basic tasks. For example, the SRT system may (i) update the display device or PDA 38 with the current GPS location of the SRT 1; (ii) receive updates from other SRT units in the field; (iii) send GPS coordinates from the other SRT units to the display device 38; (iv) update the PDA or display device 38 with information from a vehicle 40, 41, 42 that is being tracked; (v) send updates to the server 36; (vi) send waypoints; (vii) send vehicle status reports to the team; (viii) aid in configuring or reconfiguring the SRT; and/or (ix) provide team tracking on the web. A brief description of these functions is provided below. Optionally, it is envisioned that the SRT system may provide other functions in addition to or in place of one or more of these functions, while remaining within the spirit and scope of the present invention.

As mentioned above, the SRT system may update the display device or PDA 38 with the current GPS-established geographical location of the SRT. The display device 38 or other display device shows a map of the area around the SRT. As the vehicle moves, the map shows the current geographical location of the vehicle on the map. The SRT system is operable to keep the displayed location updated. The race SRT 1 collects geographic location information from the GPS satellite 29 using the GPS module 5 and antenna 3. The microprocessor 13 stores the information in memory, such as random access memory (RAM), and sends it by the BLUETOOTH® device or link 12 (wireless) to the display device or PDA 38. The display device 38 shows the current location of the SRT 1 on the map along with the locations of other vehicles within the “view” of the SRT.

Optionally, for example, the SRT system may receive updates from other SRTs in the field. Inbound messages come through the satellite antenna 2 and modem 4 and into the microprocessor 13 (FIG. 10). The microprocessor 13 decodes the message to determine the latitude and longitude of the remote SRT. Such messages may be referred to as state-of-the-world (SOTW) messages. SOTW messages may include, for example, (i): message tracking data; (ii) a vehicle ID; (iii) a waypoint flag (whether or not the message contains a waypoint); (iv) a message timestamp; (v) a GPS location; (vi) a GPS timestamp; and/or (vii) a vehicle speed (such as in miles per hour (mph) or loots or kilometers per hour (kph) or the like).

Optionally, the SRT system may send GPS coordinates from the other SRT units to the display device or PDA 38. The microprocessor 13 sends the GPS data from the “watched” SRT units via BLUETOOTH® communication link or device 12 to the display device 38. The display device may perform the necessary calculations to display the information on the map and details screen, such as in a known manner.

Optionally, the SRT system may update the display device or PDA with information from a vehicle that is being tracked. When an SRT is tracking another SRT, the display device 38 shows the GPS coordinates, GPS timestamp, vehicle speed, and vehicle direction of travel of the tracked SRT or vehicle. The GPS coordinates, timestamp, and speed arrive as data from the remote or tracked SRT. The display device or PDA 38 calculates the vehicle direction of travel by comparing the last known position with the current position.

Optionally, the SRT system may send updates to the server 36. Each race vehicle or vessel SRT 1 sends updates to the server on a regular basis. Each up bound packet (transmitted from the SRT 1 to the satellite) may carry the following information: (i) GPS position (latitude, longitude); (ii) GPS timestamp; (iii) an identifier (ID); (iv) altitude; (v) vehicle speed (such as in mph or knots or kph or the like); (vi) a vehicle directional heading; (vii) a horizontal dilution of precision (indicates the precision of the GPS reading); (viii) a destination address (when sending waypoints); and/or (ix) data used to track message handling (makes sure packets are not being lost).

Optionally, the SRT system may send waypoints, such as to the race vehicle SRT 1. As is known in the navigation system arts, a waypoint is an intermediate destination along an intended route. GPS systems are typically capable of showing a straight-line path from one point to another, which works well for aircraft and ships on the ocean, but land navigation usually requires navigating in a more indirect manner. For example, a desert racing course may use several thousand waypoints to define the non-linear route for the vehicles to travel.

Sometimes race teams want to use a waypoint of their own choosing as a meeting point. The SRT system of the present invention makes it possible for a chase vehicle, located somewhere along or near the course, to designate a pit stop by sending its current location to the race vehicle as a special waypoint. For example, the chase vehicle occupants can send a waypoint to the race vehicle SRT 1 that is indicative of the location of the chase vehicle 41 or of a location where the chase vehicle intends to be at the time the race vehicle 40 arrives at the location. To accomplish this, the chase vehicle occupant first establishes the race vehicle as the “tracked vehicle”. Then the chase crew member enters a “waypoint command” on the display device or PDA 38. The display device or PDA 38 sends the command to the chase vehicle SRT 20 through the BLUETOOTH® module 12. The chase vehicle SRT 20 then processes the current GPS location from the GPS module 5 and sends the current chase vehicle coordinates (or, optionally, manually inputted coordinates), through the communications pathway 30 and to the servers 36. The servers 36 receive the waypoint data and send a data packet back through the communications pathway 30 to the race vehicle SRT 1. The race vehicle SRT 1 sends the waypoint data trough the NMEA 0183 bus 9 to the race vehicle's primary GPS unit 37 where it appears on the unit's display (although optionally the waypoint data may be displayed on a separate display device in the race vehicle). The driver or crew of the race vehicle 40 then may head toward the geographic location indicated by the displayed waypoint to meet up with the chase vehicle 41.

Optionally, the SRT system may send vehicle status reports to the team. As described above, each SRT is equipped with a three-axis accelerometer 21 capable of determining the vehicle's orientation (upright, on the side, or upside down). Data from the accelerometer 21 is processed in the microprocessor 13 and sent along with the GPS data to the team web site. The SRT system is designed to provide timely updates without any operator involvement. The SRT sends out regularly scheduled updates as long as the SRT has power. Should a vehicle become damaged or inoperable, the SRT 1 or 20 continues to send updates to the server 36 enabling team members or other support personnel to locate the vehicle.

Optionally, the SRT system may configure or reconfigure the SRT. Sometimes, a team may want to reconfigure the SRT to optimize performance or functionality of the system. SRT system 100 may accomplish this through software configuration changes. No hardware modifications are required. To do this, the SRT 1 or 20 is capable of receiving configuration data from the server or USB port. For example, a technician or administrator may build a configuration packet and transfer it to the SRT 1 or 20, such as through the server or USB port of the SRT.

Optionally, the SRT system may provide team tracking on the web site. In addition to sending updates to the team vehicles or the like, the servers 36 may also post the information to the Internet 33 where it can be viewed on any personal computer (PC) 34 connected to the Internet 33 to allow non-race-participating individuals to view the location and information relating to the race and/or chase vehicles involved in the race. Optionally, the website may have team specific pages for authorized team members to access and view on their computer monitor.

Optionally, the SRT system may provide additional communication means between the chase vehicles and/or between the race vehicle and chase vehicles. For example, the SRT system may allow chase vehicles to send a text message to the race vehicle. Operators can enter a text message into the display device 38 and address the message to any other SRT in the system. The display device 38 will transmit the message via BLUETOOTH® or wi-fi or other wireless communication to the SRT. The SRT transmits the SBD message to the central monitoring station (CMS) 36 via satellite 31. The CMS 36 forwards the packet back through the satellite 31 to the appropriate SRT. Alternatively, the system could be configured to bypass the CMS by sending the message from one SRT via satellite and then directly to another SRT.

For example, brief messages (and optionally pre-entered text messages) may be selected and communicated to the race vehicle and displayed on the race vehicle's display. The messages are preferably kept short to reduce distraction to the race vehicle driver and to reduce or limit the size of the transmission packet to the race vehicle SRT. Optionally, a text screen may be provided in the race vehicle to display such incoming text messages from chase vehicles. The race vehicle navigator may also or otherwise be able to send pre-programmed text messages by selecting a message and pressing an associated one of several buttons adjacent to the text display (such pre-programmed messages help to reduce the distraction to the driver or navigator of the race vehicle when sending the text message). Optionally, the chase vehicle occupants may be able to send text messages to other team vehicles, such as other chase vehicles. The display devices or PDAs of the chase vehicles may act as the input device for text messages from chase vehicles. The messages can be sent to a single vehicle or a group of vehicles via incorporation of a target identifier in the message (whereby the server determines the targeted vehicle and communicates the message accordingly). Optionally, if text messages are communicated to all vehicles or all of the SRTs of the team, the team may elect that the race vehicle SRT may be configured to ignore all text messages except those sent directly to the race vehicle.

### Communication Data Packets

The tracking and monitoring or SRT system of the present invention relies on the ability to send small chunks of information, very quickly, from one device to another. These chunks are called “packets”. Packets allow the SRT system to send messages through the satellite network and direct them to a particular or designated or selected receiving device (SRT). Packets are much like e-mail where they have a sender address and a recipient address. To make packets more efficient and make sure the packets contain only information relevant to the recipient, a server of the system logs all the position information that comes into the server and assembles, or collates, the necessary information that needs to go to each SRT. This process bundles the most current position information for the vehicles in each view and sends it out in customized packets for each SRT.

### Packet Structure

To minimize airtime charges and airwave congestion, the SRT system 100 is preferably programmed to use satellite communications as efficiently as possible. To enhance or optimize or maximize the carrying capacity of satellite communications at a reduced or minimum cost, it is desirable to carefully package each transmission. The goal is to use as much of the available space in a transmission as possible and to send transmissions only when necessary. To accomplish this, SRT system 100 uses two techniques: packet chaining and scheduling.

To use up space or “fill up” the transmission units, the SRT system combines or collates smaller packets of information or data into a single transmission unit. This technique is known as packet chaining. Such a process is desirable since combining multiple packets into a single transmission unit saves airtime charges. To optimize the number of transmissions, SRT system 100 uses a scheduling algorithm based on business case rules. The scheduling algorithm controls the rate at which information is disseminated. The goal is to have reasonably current information without clogging up the system or unduly increasing operating costs. Together, packet chaining and packet scheduling keep the data moving while using the minimum airtime.

The SRT system 100 collates the packets into single or individual transmission units. Packet collation 46 (FIG. 8) is the process of making a package of information that needs to go to a single device. The SRT system 100 assembles the most current position information for the vehicles that the SRT system is monitoring and sends it in one chunk or packet to the respective race and/or chase vehicle SRTs.

Optionally, and with reference to FIG. 8, a team administrator 47 may connect to the server 36 to define the view definition table 43 and view assignment table 44 for each SRT or display. The information in those tables is used in the packet collation process (which may also use the current vehicle data 45) to assemble update packets 10 for each of the SRT units in the field. Each packet 10 contains information for each of the monitored vehicles in each SRTs respective view on their display device. As the server receives updates from the field, the updates are collated into the packet destined for the field units. This information may also be made available to the public (or to authorized users) on the website.

### Types of Packets

The SRT system may communicate different types of packets of information to the vehicles depending on the targeted vehicle and the particular application of the SRT system. For example, the SRT system may communicate variable length packets to the vehicles. Such variable length packets do not have a specific length to them. An encoder/decoder contains the logic to split the transmission unit into the appropriate sized sub-packets.

Because the minimum size of a transmission unit (for example, with Iridium satellite communications, the transmission unit size is about 30 bytes) is typically larger than the amount of sensor data (time, position, speed, etc.) that can be usefully gleaned from the vehicle and communicated to the server, the SRT system may use the unused bytes available in the packets to send diagnostic and/or performance information generated by the system equipment. For example, such data may include (i) the number of failed send attempts since last successful send; (ii) the number of failed receive attempts since the last successful receive; and/or (iii) the globally unique identifier (GUID) of the most recently received transmission. Other information data may be provided depending on the particular application of the SRT system.

Optionally, the SRT system may communicate configuration packets to one or more of the SRTs. Such configuration packets received by the SRT function to change the SRT configuration. The satellite modem and the GPS unit thus may be configured or reconfigured remotely by sending a configuration packet. Configuration packets can also carry event name, team name, vehicle type, and the SRT name and/or any other suitable or useful information, depending on the particular application of the SRT system.

The SRT system thus is operable to create or generate the desired or appropriate packet of information for communicating to the SRTs in the field. The SRT system may perform packet chaining and scheduling to enhance the communication of the packets to the SRTs. The scheduling of the packets by the SRT system allows the SRT system to communicate the important packets to where they need to be before handling lower-priority packets. The packets thus may be optimized or scheduled or prioritized based on a number of characteristics or criteria. For example, the SRT system 100 may use the following scheduling methods to optimize the flow of information:
The SRT system may adjust the SRT transmit interval if the vehicle is not moving. Non-moving vehicles do not need to repeatedly transmit the same position. Extending the interval for non-moving vehicles puts less redundant data into the system.
The SRT system may send live data only once. If a communication encounters a problem in the transmission or receipt of the communication/message/data, the system waits until the next scheduled update and sends a new set of data because it is generally not useful to send outdated “live” data.
Text messages and waypoints are preferably resent until they are received by the SRT.
The SRT system may provide “opportunistic sending”, which lets low-priority packets wait until a higher-priority packet is sent. The high and/or low priority packets may be chained together and sent as one transmission unit to save costs.
The SRT system may send team views in state-of-the-world (SOTW) packets. This updates all team members in a particular view at one time.
Alternatively, the SRT system may send staggered state-of-the-world (SOTW) packets to update the data in a view in stages rather than all at once. This option may be desired when the various vehicles in a view have significantly different update rates, or when some of the positions in a view are more time-sensitive than others.

### Race Team Views for Displays

Optionally, and desirably, the SRT system 100 may be operable to group vehicles (iconistic representations of vehicles on a geographical map) into a “view” for displaying to the driver or crew of the chase vehicle and/or the race vehicle and/or the other team members at the team base. When a team has a sizable group of vehicles, watching all them moving about a map can be confusing. To limit screen clutter, SRT system 100 defines and utilizes selected views to define what vehicles are represented on the displayed map of each vehicle or team station, depending on what may be desired or necessary for viewing by the user or viewer of that particular display device or PDA. By defining specific views, the team administrator 47 is able to let people see what they need to see while limiting extraneous information.

To configure a view, the team “administrator” logs onto the appropriate website and enters or inputs which vehicles should appear in a particular view for the particular vehicle SRTs. Then, for each SRT 1, 20, the administrator inputs what view or packet of information the respective SRT is to display. The server 36 uses this view information to collate the packets that go out to each SRT. For example, each support or chase vehicle may have the race vehicle(s) and other support vehicles within the view of the display or PDA 38 of the chase vehicle 41, 42. If desired, the administrator can alter, such as during the race, the view by adding or removing vehicles as required. Also, for example, the race vehicle view may be limited to displaying only the race vehicle location and the nearest chase vehicle or vehicles to limit the quantity of moving vehicles represented on the race velicle's display screen.

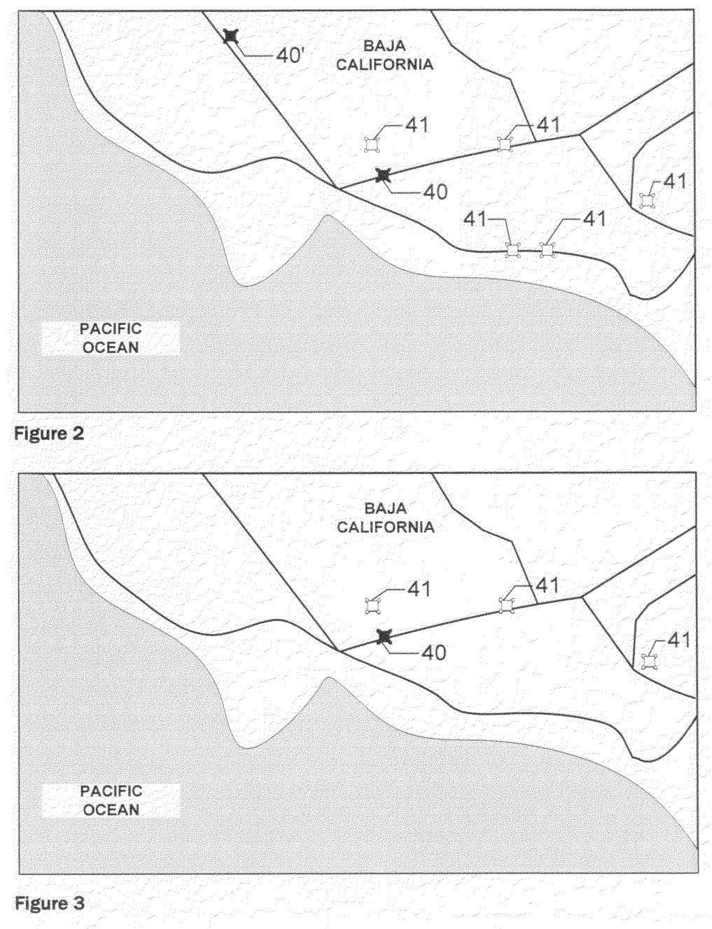

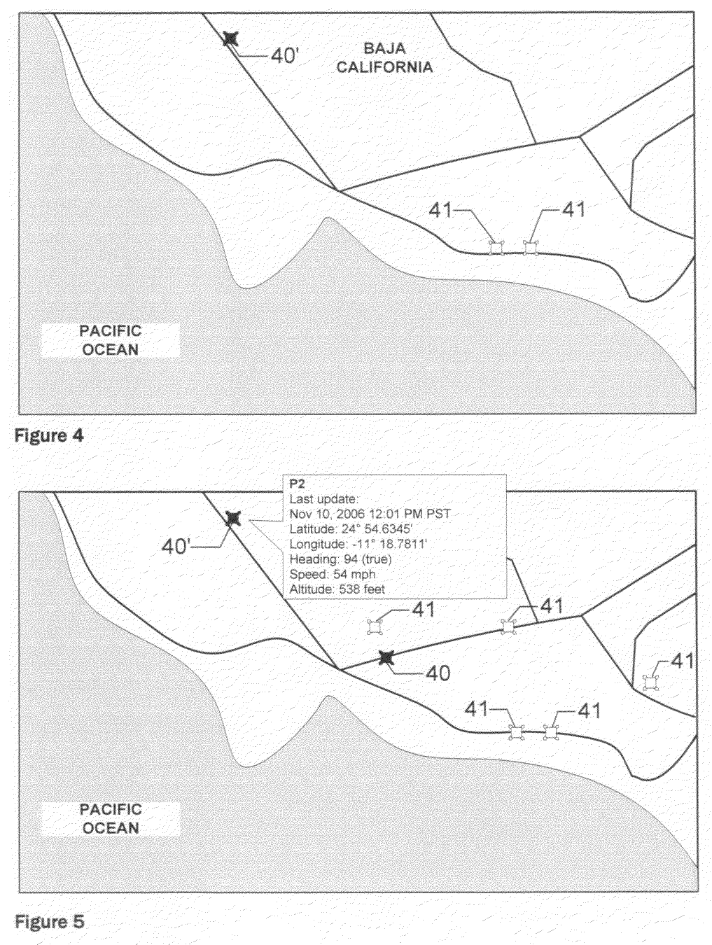

SRT system 100 thus may provide different views or displays for different vehicles and/or at different times during the same event or race. For example, the display or view of FIG. 2 shows the entire team (which may have two race or subject vehicles 40, 40′ and multiple chase vehicles 41) and status information or data for one of the race vehicles 40′ (FIG. 5), while the display or view of FIG. 3 shows one race vehicle 40 of the team and the support crew or chase vehicles 41 for that race vehicle (and may include the status information or data for one of the represented vehicles), and the display or view of FIG. 4 shows the other race vehicle 40′ of the team and the support vehicles or chase vehicles 41 for that race vehicle (and may include the status information or data for one of the represented vehicles). The chase vehicles of a team may be the same for each race vehicle or a subset of the total chase vehicles of a team may be particularly associated with one of the race vehicles of the racing team.

The capability to define the particular desired or appropriate view for the user or users of the system allows a team administrator 47 to limit the field of view for each support vehicle. This capability allows the users of the system to see what they need to see while making things simpler by avoiding “clutter” on the screen.

Creating the map may include downloading course data and converting the data to a map. This may include extensive mathematical calculations and determining which points to use as a representative sample. In the process of creating the map, data may be down-sampled for processing efficiency. To make the information accessible to the chase vehicle display devices 38, the SRT system programmers may do one or more of the following in advance of the race:
download base maps to the display device or PDA 38;
import course data from the official race site (data recorded at regular intervals along the race course; sometimes as frequently as every 50 feet);
use the course data to calculate mile markers along the route;
use a subset of the data to create points on the PDA or display device map to represent the race course;
when available, add additional geographic data (uncharted roads and trails) to the map;
allow the team member to zoom in for greater detail or zoom out for a broader view; and/or
allow the race team to add course data to the map on the display device.

Optionally, the SRT system of the present invention may provide race data to the rest of the world (such as to race fans or to the press or news media) that is not directly involved in the competition. For example, the SRT system may provide race telemetry data or information to a server by way of a satellite gateway and the Internet, whereby the server may make the information available on a website, such as a website like the IonEarth website (www.ionearth.com). Internet viewers can view the race progress by logging onto the website. The website may be available to the general public or may only allow authorized users to log on to the site to view the race information. Due to the desire to not let other teams know of the location of a team's race vehicle, it may be desirable to only allow authorized team members to access information that is related only to their team, or to only provide data to the public in a time delayed manner, such that the viewers are not viewing the “live” race.

Optionally, each race team may have a page on the SRT system web site that displays the positions and status of the race vehicle as well as chase vehicles during the race. Optionally, a combined web page may show the position of each SRT system-equipped race vehicle. Optionally, the web page may store data into a database and generate XML reports as output. Optionally, the web page may allow viewers to replay the race at a later time.

The race communications of the SRT system thus may extend beyond the race course. The data that passes between the vehicles is captured on the web server and may be published in near real time during the race. Thus, interested parties can log onto the appropriate website to monitor the progress of all race vehicles outfitted with SRT units. Alternatively, instead of watching just the racers, the viewers may opt to monitor the vehicles of a particular team. Team viewing pages may highlight the race vehicle as well as support/chase vehicles in the field. Thus, the present invention may provide a useful communications system for the race team, while also enhancing the event or sport for the non-involved people, such as race fans or the press or the like.

For example, FIG. 11 shows a web version of the SRT system map. In this view, the course is not visible. The map shows two vehicles (race vehicle 40 and chase vehicle 41) and the telemetry data or information for the race vehicle 40. Web viewers can move their mouse over a vehicle icon to see information or data that is provided for that vehicle. Web viewers can select from different views at the website so that the users can view the vehicles that they are interested in at that time.

The SRT system not only provides a map for viewing at a website, but may also make such mapping features available to units in the field. For example, the SRT system may show the race course and team vehicles on the PDA or display device. This display is not intended for navigation, but it is a suitable representation of where vehicles are along the course.

Optionally, the SRT system may provide information pertaining to another team's race vehicles for displaying on the displays of the chase or race vehicles. However, because teams may not want the locations of their race vehicles and chase vehicles known to the competition, it is desirable to only provide vehicle information on the team vehicles to each team. Optionally, however, the SRT system may provide split time data on other race vehicles (not associated with the particular team) so that the teams have information regarding how far ahead or behind they may be from the other teams' racers. For example, when a race vehicle passes a course check point (or a check point established by the SRT system provider), the SRT system may provide a time and ranking of that vehicle at that check point (FIG. 25). Each team thus may have limited information regarding the race vehicle or vehicles of the other teams, but such information is preferably limited to split time information or the like.

### Race Management Communications

The system can also be used by race organizers to track any number of vehicles in the race for safety, time-keeping or verification purposes. Tracking can be automatic for vehicles equipped with an SRT. To track vehicles not having an SRT, officials may use an SRT to record each vehicle as it crosses or passes the starting line, a checkpoint, or the finish line, for example. One benefit to race officials is the ability to automatically detect vehicles and communicate that information amongst race officials regardless of the location of the vehicles.

Optionally, and preferably, the race organization may further automate the system by requiring each competitor to carry an RFID chip, or a similar device capable of providing electronic identification, to aid in data collection. At specified locations along the course, in addition to the start and finish lines, an RFID scanner or similar device may be employed to identify and report vehicles as they pass each check point along the course. The identifying device automatically feeds the data to an SRT at that check point, which in turn communicates the data to the central monitoring station (CMS) 36. The CMS 36 records, tabulates and composes the data into an outbound short burst data (SBD) packet. The CMS 36 also posts the information on the Internet server. Race scoring officials and media outlets may obtain the data either directly from the satellite or from the Internet when a connection is available.

### Check Point Reporting

One embodiment of the present invention provides a means of automating, either partially or fully, the data gathering and reporting at racing check points. Check points provide some certainty that vehicles have completed the entire course and have not taken a shortcut somewhere between the starting and finish lines. Another purpose is to account for vehicles that may have broken down or had an accident since the previous check point. Race organizers or officials may use a hand-held computer to record the time that each vehicle passes a check point. As the data is gathered, the system sends the data via satellite to the central monitoring system where the results are tabulated and redistributed to interested parties along the race course, such as at other check points, and/or to race vehicles or emergency personnel. These up-to-the-minute reports can keep everyone involved in the race advised of the status of every competitor.

Also, race teams may use the system to provide their own race analysis. This may be accomplished in part by the automatic reporting of the race vehicle SRT 1 and in part by the manual recording of times and locations for other vehicles of interest.

### Automatic Check Point Reporting

The system may use two types of automatic check point reporting. In the first type, a GPS unit may detect that its race vehicle is at a check point. In the second type, an RFID scanner, electronic transponder, or the like detects the race vehicle (having an RFID chip or the like) passing within its detection range.

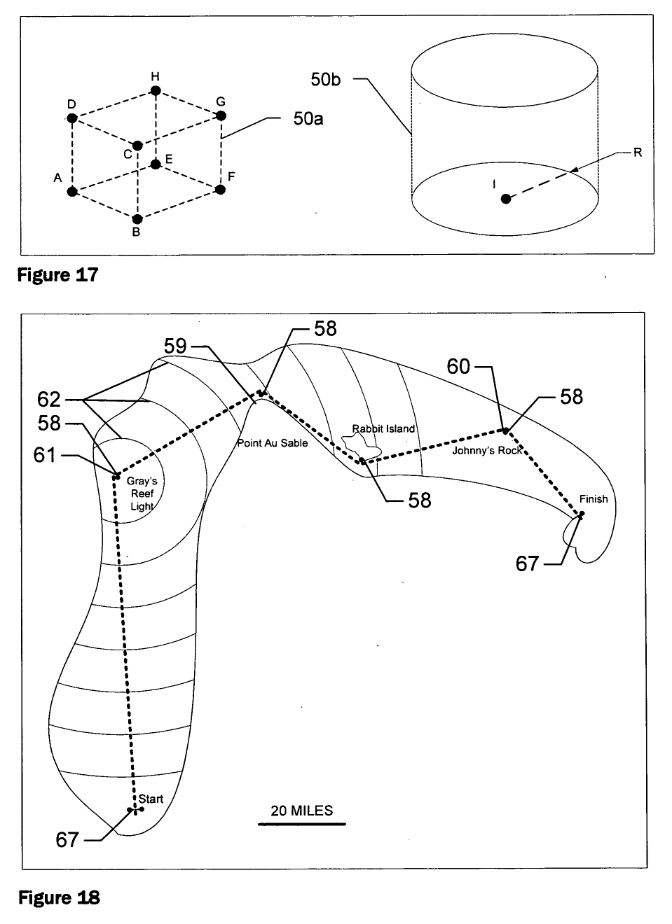

For GPS check point reporting, the GPS receiver determines the SRT-equipped race vehicle's current position as the vehicle travels the course. The SRT processes the location information and determines if the vehicle is in the proximity of a predefined check point or has passed through a check point. A check point may be defined as a virtual boundary defined by GPS coordinates. The check point boundary can be thought of as an imaginary gate in one, two, or three dimensions. A one dimensional boundary 48 (FIG. 15) forms a line segment such as a finish line or starting line. A two-dimensional boundary 49a, 49b, 49c (FIG. 16), defines an area on the surface of the earth, wherein if the vehicle enters the shaded area within boundary 49a, 49b, 49c, it has reached the check point. Three-dimensional boundaries 50a, 50b (FIG. 17), extend upward creating a space through which the vehicle is required to pass. Additionally, it will be appreciated that a one-dimensional check point could be extended laterally and/or vertically to create a two-dimensional boundary.

For vehicles constrained to a certain path, such as a highway or a narrow canyon, race organizers may define the check point as a one-dimensional boundary 48 intersecting the highway or canyon along the race course.

In the case of case of marine events, such as sailing races and the like, check points are often locations that naturally lend themselves to dividing the course into stages. Land masses that require boats to make a change of course, navigational aids, such as buoys and lighthouses, and channel entrances often provide recognizable check points. Check points can also be defined using GPS coordinates. GPS check points offer greater flexibility because they can be placed or programmed anywhere.

In areas where drivers may diverge from a narrow path, race organizers may define the check point boundary in two-dimensions. This might be the case where drivers, or boat captains, have to find their way through a technically difficult area to traverse. The boundary could be in the shape of a circle 49b or any polygon encompassing the challenging area, as in polygon 49c. Such a boundary would provide a time the vehicle entered the challenging area and the time it left the area, giving an interesting statistic of which vehicle made it through the obstacle in the shortest period of time.

The boundaries of the check point are pre-programmed into the system as a series of points or facets. The race organization determines how narrowly to define the check point boundary on a case-by-case basis. Optionally, and desirably, the boundary may be constructed to provide the most accurate information possible by limiting the boundary to the extent needed to encompass the potential routes that vehicles might use to negotiate the check point.

When the vehicle arrives at a check point, the SRT composes a short burst data (SBD) message and sends it to the CMS 36 via the satellite communications network. On a predetermined interval, the CMS 36 collects and tabulates the latest information for all of the vehicles, and sends a report back out to the units in the field or to other remote units or communication devices, such as to an internet site or e-mail address or the like for others to access.

As discussed above, identification of the vehicle at the check point may be detected by an RFID scanner or similar device connected to a stationary SRT at the check point. In this case, the capabilities and limitations of the detection equipment govern the aperture through which the vehicles must pass. As the SRT collects the data, it sends regular updates to the CMS 36 via the satellite communications network.

### Manual Check Point Reporting

A person monitoring a check point uses a display device in conjunction with an SRT to record when vehicles arrive at the check point. The person may use a vehicle mounted SRT or a portable or handheld or backpack version of the device. The device is pre-programmed with a list of vehicles competing in the race. Preferably, the vehicles are listed in their starting order to simplify record keeping during the race. Additionally, the system may be programmed to rearrange the list based on the reported positions from other check points.

As a vehicle arrives at the check point, the operator activates a “stopwatch” function or control on the display to record the time and location of the event. To record arrivals, the operator may select a vehicle's identifier from the list and then press the stopwatch control on the display device to record the time for that vehicle. Or, in the case of a number of vehicles arriving at the check point in rapid succession, the operator may first press the stopwatch control multiple times—once for each vehicle—to record a number of timestamps. After the rush subsides, the operator can then use the interface to manually correlate the vehicles in the list with their respective times.

### Automatic Split Times

Optionally, the system may provide split times for all SRT-equipped race vehicles. The system can be programmed to provide split times at predetermined geographic locations or at predetermined time intervals.

### Distance-Based Intervals

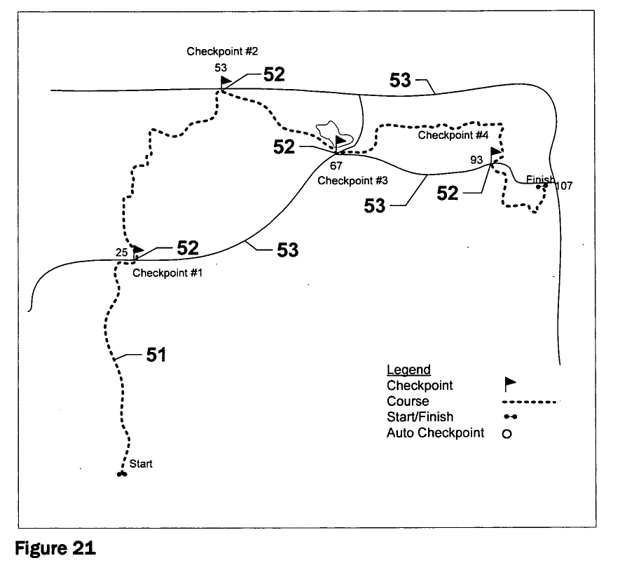

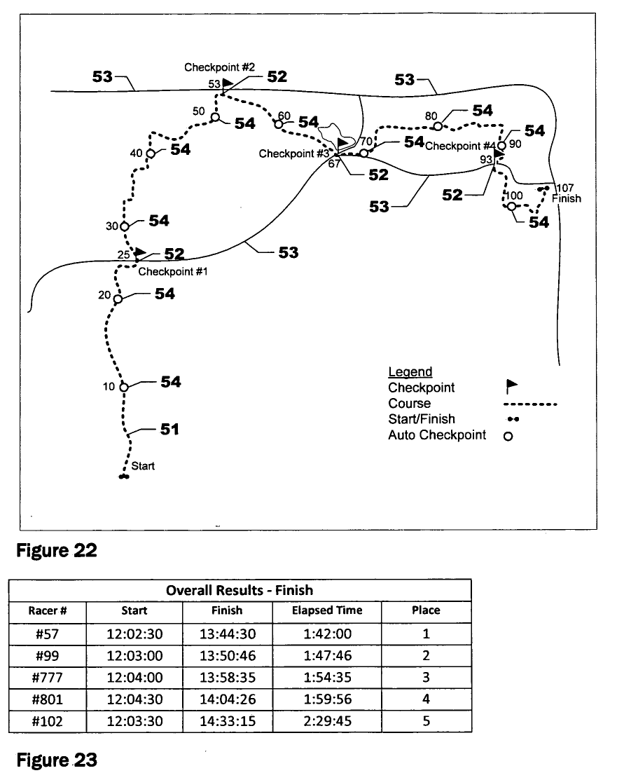

To provide split times based on distance intervals, the first step is to define the points along the course where it is desirable to have the vehicles report. The locations could be at official check points or at regular intervals such as every ten miles, or a combination of both (FIGS. 21 and 22). At locations with official check points, the data may be collected manually or automatically, as discussed above. For unmannered locations, an embodiment of the present invention automatically collects data for each SRT-equipped vehicle. For automatic reporting, the positions are programmed into the system and the CMS 36 distributes the list of check point coordinates to each SRT. Alternatively, these coordinates can be preloaded into the SRT via wireless communications or by a direct wired connection such as Ethernet. The SRT stores these coordinates in onboard memory for use during the race. FIG. 21 shows a map of an exemplary race course 51 with several mannered check points 52, such as at 25 miles, 53 miles, 67 miles, and 93 miles into the race, such as might be found in a typical race where course 51 crosses roads or highways 53. FIG. 22 shows a map of the same exemplary race course where an embodiment of the present invention is employed to track the race. In this version, a number of virtual or automatic check points 54 have been added to the course at ten mile intervals to gather additional data.

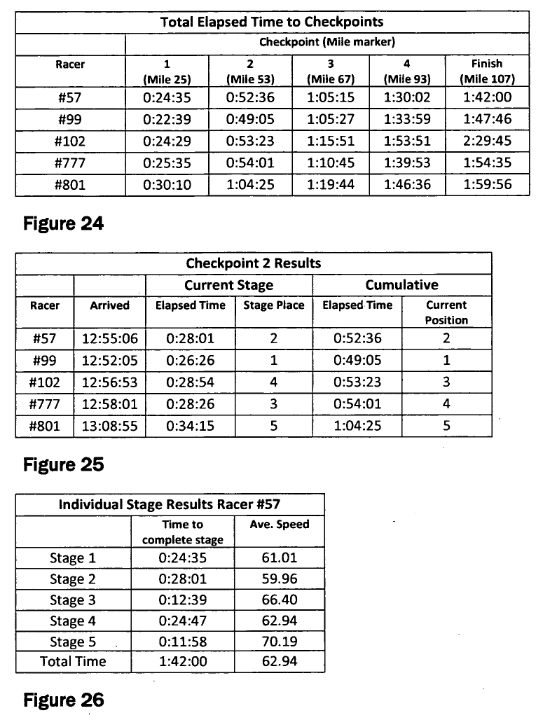

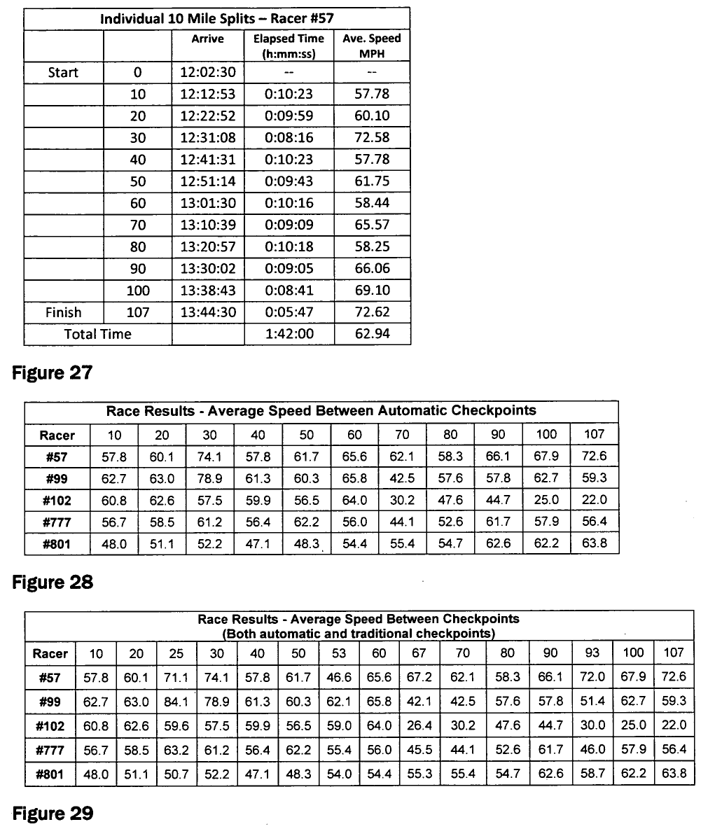

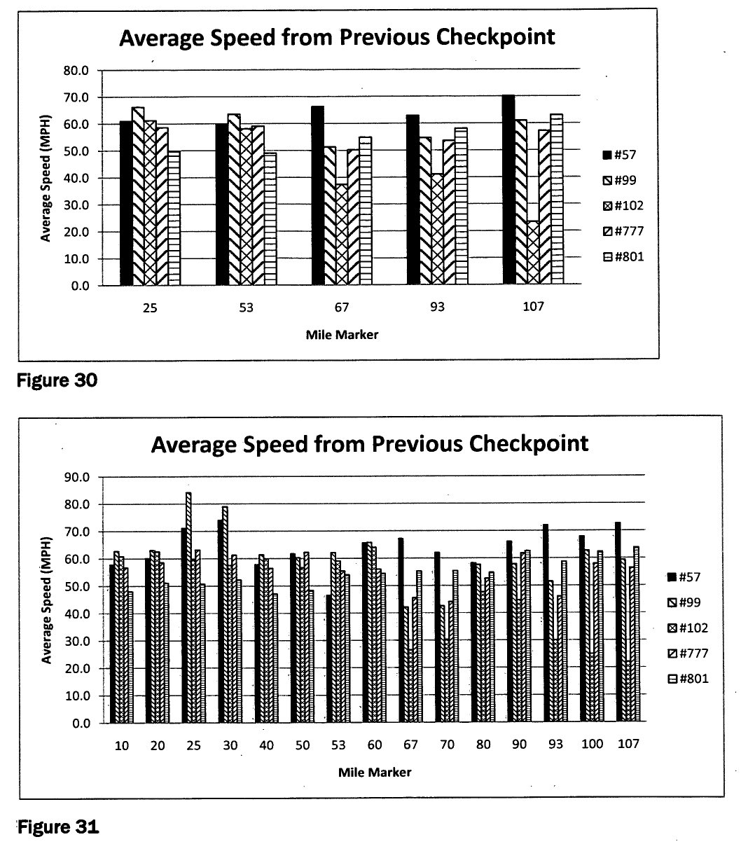

When a race vehicle 40 reaches a reporting point, such as determined by the GPS module 5 in the SRT 1, the system composes a short burst data (SBD) message containing: the location of the reporting point, the time the vehicle 40 reached the reporting point, vehicle identification or SRT identification, and the time, speed and direction or heading of the vehicle. The SBD message is sent via satellite 31 to the CMS 36. The CMS 36 stores and tabulates each vehicle's arrival and computes the amount of time it took for the vehicle to complete the interval. In addition, the CMS 36 determines the accumulated time to a given reporting point based on the vehicle's official start time. The cumulative time gives an indication of the vehicle's race standing, which can be compared with other vehicles' times to cover the same distance. FIGS. 23-26 and 30 show results that might be obtained during a race, either with or without using the system of the present invention. FIGS. 27-29 and 31 show expanded results that might be obtained by using the system of the present invention during the same race. Thus, the system can accurately provide up-to-the-minute race standings, such as class leaders or overall leaders, as vehicles finish the various stages. The information is also available to race teams for post-race analysis. The analysis can be extended to include average speeds between check points, both manual and automatic check points, such as shown in FIGS. 27-29 and 31. FIGS. 30 and 31 are graphical representations of the data shown in FIGS. 23 and 29, respectively.

### Time-Based Intervals

The system is also capable of providing split times based on a predetermined time interval such as every ten minutes or every quarter hour or the like. The specified interval could be more or less, depending on the particular application and desired reporting results. Additionally, the system may function in a way so that the interval is synchronized to the starting time for each vehicle. For instance, each vehicle could report its current position as it completes each hour or half-hour of racing.

The SRT 1 sends the information at the appointed times and the system calculates the distance each race vehicle 40 has traveled during the interval and reports those distances to the SRTs in the field. Time-based intervals provide regular updates regardless of how much progress has been made by the race participants.

### Sharing Split Times

Race teams sometimes place observers at strategic locations along to course to collect data. The system of the present invention provides a means to reliably collect and share that information in remote areas. In a way similar to official check point operations, team observers can use an SRT and display device to collect data for any number of race vehicles by recording timestamps as each vehicle arrives. The system records this information and distributes information among the team members.

Because the observers are investing effort into collecting the information, they may not wish to share the information with other teams. Optionally, however, the observers may want to collaborate with one or more other teams to share the information. The entity that collects the information has the capability of determining how that information is shared with other users of the system. Prior to the race, teams may opt to create a filter to determine which information they will make available to other teams. For example, a team could willingly disclose information about racers in other classes, but withhold information regarding other racers competing within the same class as their particular racer, leaving it up to their direct competitors to gather information on their own. Optionally, a team might elect to participate on a collaborative basis with other teams and freely share information between two or more teams.

The system uses each team's preferences to apply filtering rules and algorithms to compose filtered reports for distribution. The CMS 36 applies the appropriate filter to the data and sends the filtered information to the appropriate SRTs. For information gathered by SRTs under the control of the race organization, the organization may determine how much information is shared and when it is shared with race participants by establishing its own set of filtering criteria.

### Terrain Performance Analysis

Desert racing and other remote racing events are conducted in varied terrain. Race courses may include everything from paved roads to silt beds to rocky ridges to mud pits and swamps. If a system user, whether a racing team, a racing organization, or a media entity, is interested in determining how well drivers performed in a particular type of terrain, the system user could divide the course into stages based on the terrain. By tracking how long it takes vehicles to negotiate each stage, one can determine how well one racer performed for each type of terrain. FIG. 30 illustrates average speed between manual check points for the race of FIGS. 21 and 22. FIG. 31 illustrates the potential of automatically collecting data at any number of predetermined points along the course 51. The system of the present invention allows the possibility of accurately measuring racer performance while eliminating the need to place personnel at each check point to collect data.

### Sailing Races or Events

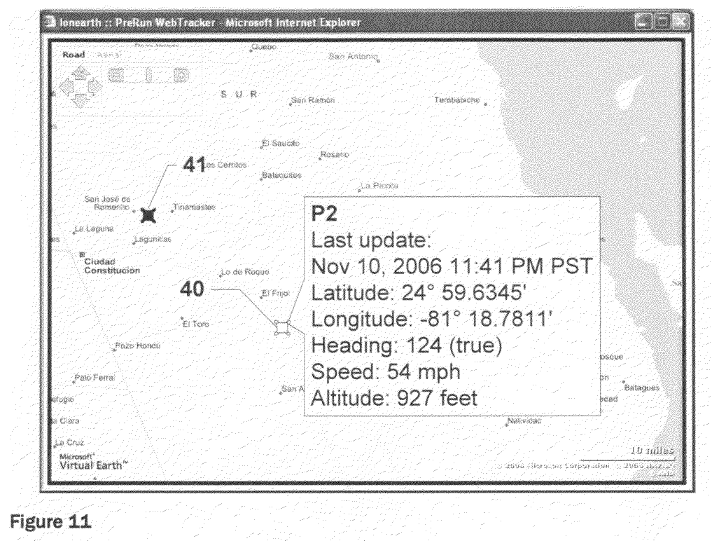

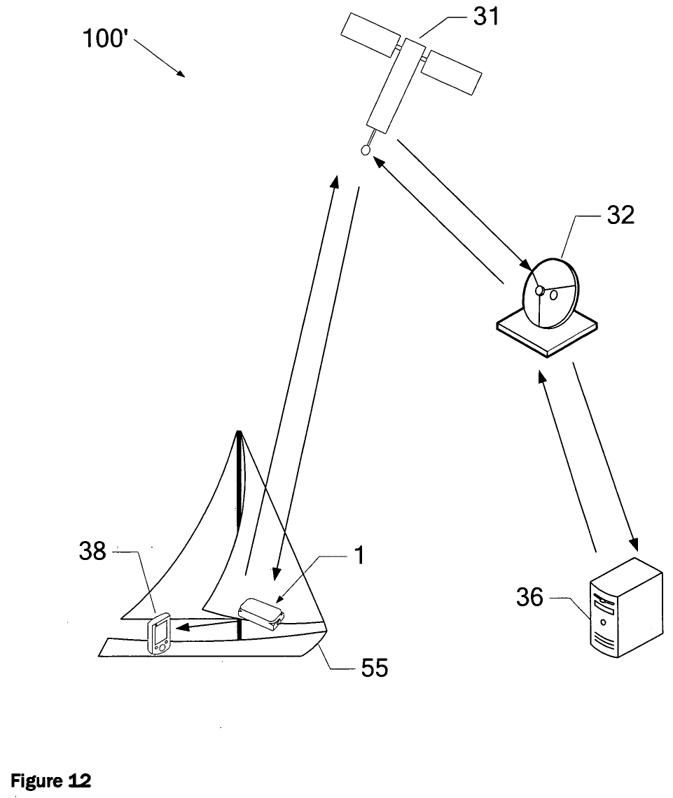

In another embodiment, the system 100′ of the present invention includes a process for providing situational awareness, split times and other race statistics, organizational infrastructure, safety measures, and entertainment content for sailing races and similar events by automatically providing the course, speed, and position of vehicles or vessels 55 (FIG. 12) competing in a racing event. Vessels 55 (or substantially any race vehicle) may be equipped with SRT 1 and a display or PDA 38, similar to the equipment carried by chase vehicles 41 in system 100, described above. The PDA thus may inform the crew of a given vessel or boat as to the location of other vessels or boats on the course. Optionally, SRT 1 may be fed with position data for the vessel on which it is carried by a separate navigation GPS or the like carried on vessel 55, and PDA 38 may display position data received from SRT 1. It will be appreciated that the embodiments described for sailing races and similar events may use communication aspects as set forth above with respect to SRT system 100 such that additional recitation of the functionality of the system need not be repeated herein.

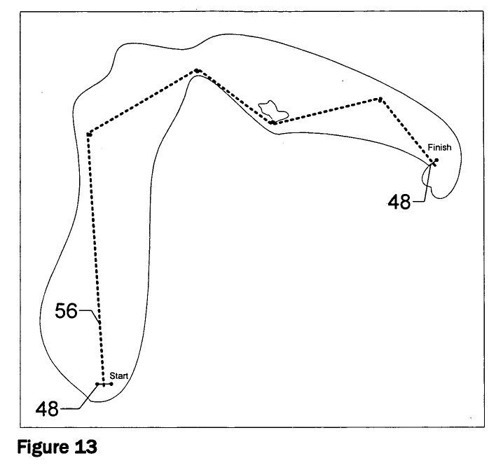

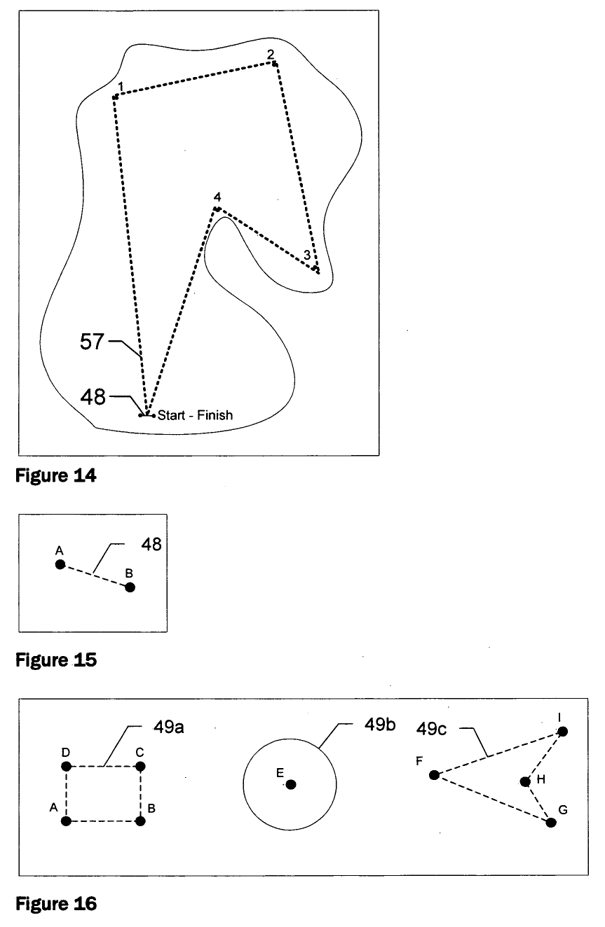

Sailboat races are a contest to see which boat can be the fastest to traverse a course. Some races are point-to-point races where the finish line is some distance away from the starting point. FIG. 13 illustrates an exemplary course 56 for a point-to-point race. Other races are closed courses 57 where the start and finish points are collocated, or nearly collocated. FIG. 14 illustrates an exemplary course 57 for a closed-course race.

Some courses cover hundreds of miles and take one or more days for boats to complete the course. In these extended races, reliably collecting position information for boats raises challenging issues. These issues include a lack of communications infrastructure throughout the entire course, a limited number of opportunities for officials to monitor the progress of the boats during the race, and even a tendency of crews to withhold their true position fearing that revealing such information will give their competitors some tactical advantage.

The system of the present invention offers benefits to sailing crews, race organizers, and sports media outlets desiring to cover sailing races, as will be described in greater detail below.

### Racing Crews

In long races, competitors are often out of sight of each other. Various weather conditions, darkness, distance and land masses can make it difficult or impossible to determine the location of a competitor. Not being able to see other competitors limits a captain's situational awareness and his ability to make strategic or tactical decisions during a race. Many captains are unaware of, or unable to determine, their standing in a race until many of the boats have crossed the finish line.

Currently, some races require participants to provide their position as determined by GPS at some interval. However, by the time these reports trickle back to other crews, the value of these updates is limited and often only provides outdated information. Such a system depends on the participants' willingness and ability to report their position via radio or cellular telephone. Manual reporting brings with it the possibility of participants intentionally providing deceptive information. Such manual systems are irregular and infrequent, resulting in an inconsistent or incorrect indication of the boats' actual positions at any given time. Such information provides some clues as to the other boats' whereabouts, but does not provide a reliable means for a captain to determine his boat's standing in the fleet.

Additionally, manual systems require extra interpretation to provide meaningful analysis based on racing classes. Generally, sailing races are divided into classes based on various boat characteristics. Boat captains are typically most interested in their standing compared to other boats in the same class.

### Racing Organizations

Race officials need to keep track of boats as a matter of safety and as a matter of fairness. In addition to a starting line 68 and a finish line 67, race organizers use check points 58 to maintain a level of surveillance over the racers to ensure fairness, safety, and accurate scoring (FIGS. 18-20).

Race officials have heretofore typically relied on manual reporting systems to keep track of boats arriving at check points and the finish line. In some cases, crews are required to radio or telephone a shore station to report arriving at a checkpoint. In the case of crews reporting their own positions, crews have been known to mislead other crews by reporting check point arrival either earlier or later than the actual arrival time.

In other cases, race officials are stationed at one or more points along the course to monitor boats as they pass check points 58. At manned stations, vessels 55 arriving in rapid succession can lead to data entry errors and mistaken identities. Fog and darkness can further impede the accuracy of reporting at maimed stations.

Lastly, some races rely on the honor system for boats to navigate the course fairly. In some races, boats may be separated from other boats by considerable distances, leaving it entirely up to the crew to maintain their integrity and fairness throughout the race.

### Media Coverage

The entertainment industry is increasingly providing coverage for sporting events. Sailing racing is one type of event that has received little coverage in the past. The distances covered in many sailing races—distances measured in hundreds of miles—make it impractical for the media to monitor or gather information for a substantial portion of the fleet. Often, the only news covering a race will be sporadic reports as boats cross the finish line 67. Generally, fans have no idea who is leading the race or which boat is gaining on the rest of the fleet.

### Sailing Race Benefits

The system of the present invention provides the following benefits and methods which are applicable to sailing races. However, it should be clear to any person skilled in the art that these benefits and methods may also be applied, with or without adaptation, to other types of races and events requiring navigational and tactical decision making skills.

### Race Standing

A boat's standing refers to the boat's relative place or position in relation to other boats on the course. The system of the present invention allows crews to assess their standing in the race by providing positional information for other boats in the race. The system calculates each boat's standing (or race position) and adjusts for the boat's handicap to determine current standings for the entire fleet.

### Determining a Boat's Position on the Course

In sailboat racing, as in most races, the goal is to cross the finish line 67 in the shortest amount of time. If time were the only unit of measure, the boat that was the furthest along the course at a given time might be considered the leader. However, to determine which boat is leading in sailboat racing, a number of factors come into play. These factors include starting time, boat handicap, and the actual distance made good along the course.

Determining a competitor's position in a sailing race is different than in most races because the boats are not confined to a particular narrow track or path. Instead, boats are flee to navigate about the body of water to make the best possible use of available winds. Typically, sailboats must navigate to the outside of, or sometimes between, a set of predetermined points. These predetermined points or waypoints or check points 58 may include a geographical landmark such as a point 59, shoal 60, lighthouse 61, buoy, or geographic coordinates or the like, such as shown in FIG. 18. A boat may attempt to follow the shortest, direct distance between two points; however, wind direction, weather, and boat limitations usually require boats to travel an indirect path.

Because boats usually take an indirect path, the need exists to define an equitable means of determining a boat's progress compared to other boats in the race. Generally, the system of the present invention seeks to determine the distance a boat has yet to travel to finish the race. To determine the remaining distance, the system calculates a direct-line distance from the boat to the next waypoint; adding that distance to the sum of the distances along the remaining legs of the race.

### Determining Waypoint Passage

To track a boat's progress during the race, the system uses a set of rules and algorithms to identify the next waypoint 58 and track when the boat passes that waypoint including, but not limited to the relative position to the waypoint, trends in the relative position to the waypoint, a proximity to the waypoint, and the relative position or trends in the relative position to waypoints already passed and waypoints the boat has yet to pass.

### Determining Standing

Determining a boat's standing requires knowing how far the boat has progressed in the race, how far other boats have progressed along the course and each boat's handicap. The system considers each boat's handicap and compares the distance a boat has progressed along a course with the other boats' progress to determine the current standing of each boat. The system allows a crew to compare their boat's position to the position of any other boat that is using the system.

### Course Position

One of the primary factors that may determine a boat's standing in the race is the determination of where the boats are along the course. To determine course position, the system determines the distance between each boat and the finish line. This is accomplished by adding up the distance from the boat to the next waypoint plus the sum of the distances in the remaining legs of the race. If Boat A is 21 nautical miles from the finish line and Boat B is 20 nautical miles from the finish line, then Boat B is ahead by 1 nautical mile ahead in the race from a distance perspective. The system is capable of determining and reporting the course positions of all SRT-equipped boats in the event.

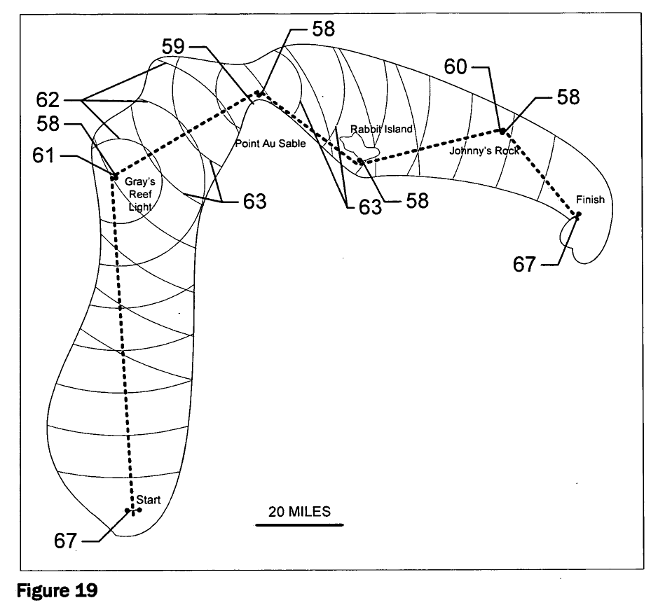

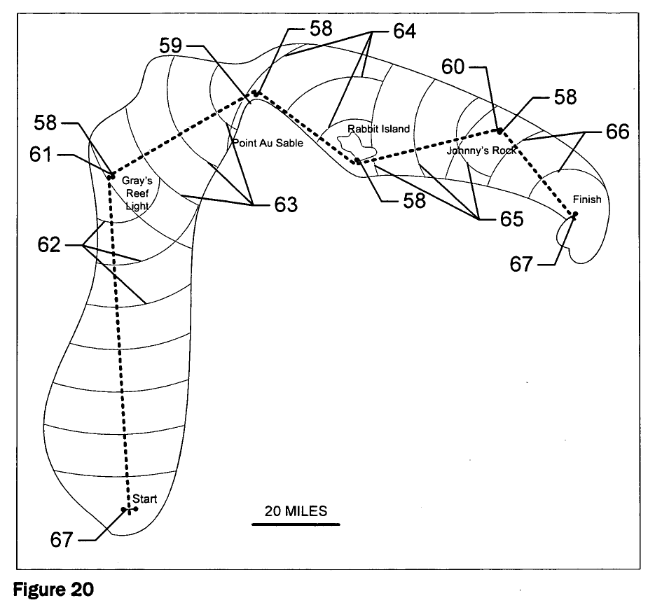

To determine course position in a nautical racing event, the system of the present invention calculates the shortest distance to the next check point 58 along the course. FIG. 18 conceptually illustrates concentric rings 62 around a lighthouse check point 61 that identify the distance to another check point or “turn” 58. FIG. 19 further illustrates the concept by showing concentric rings 63 around the second or point check point 59 in the race. FIG. 20 completes the illustration by showing portions of concentric rings 62, 63, 64, 65, 66 around each of the check points 58 and the finish line or point 67. In most cases, boats will not travel any great distances past a given check point 58 until they have rounded the check point. To avoid unnecessary clutter, the rings shown overlay probable locations of boats as they approach each check point 58. The system of the present invention is able to track boats regardless of the distance or direction from which they approach the check points 58.

### Handicap

Each boat receives a handicap rating based on the characteristics of the boat. A handicap may be determined as a number of seconds per mile. The handicap can be positive or negative. A negative handicap “penalizes” faster boats by adjusting their finish time upward; making the adjusted finish time later than the actual finish time. Positive handicaps “reward” slower boats by adjusting their finish time downward.

For example, in a 100 mile race, Boat A, with a handicap of 60, will receive a credit of 6000 seconds (100 minutes or 1 hour, 40 minutes), while Boat B, in the same race, but with a handicap of 10, will receive a credit of 1000 seconds (16 minutes and 40 seconds). Thus, if Boat B is to win the race, it must finish at least 5000 seconds (1 hour, 23 minutes and 20 seconds) ahead of Boat A (6000 seconds−1000 seconds=5000 seconds or 1 hour, 23 minutes and 20 seconds).

The system of the present invention calculates the handicap for each boat and uses that to compute the adjusted finish time for each boat.

### Starting Time

Sailing race organizers often divide races into classes with each class having its own starting time. Boat captains race primarily against boats in the same class. However, race organizers often recognize the overall winner and the fastest boat for the race. The overall winner is the boat that finishes in the shortest adjusted time, regardless of class, after taking handicaps into account. Because each class of boats has its own starting time, to determine an overall winner, each boat's starting time and handicap have to be considered. The system of the present invention provides automatic scoring for the overall winner by adjusting each boat's elapsed time by the differential between the start of its class and the starting time for the first class.

For determining the overall fastest boat, the system of the present invention determines the shortest elapsed time to finish the race, taking into account the starting time differential for each class.

### Reporting Results

The system of the present invention uses two methodologies to report current race standings: predictive standings and absolute standings.

In the case of racing events, predictive standings are an estimation of how well a competing vehicle, such as a race car or a boat, will have to perform to achieve an equal standing with another competitor. Predictive standings use the latest information to estimate how long a competitor will take to get to the next waypoint or the finish line. A driver or captain can use the system to compare a prediction of how long it will take his or her vehicle to finish the current leg of the race with the prediction of how long it will take another competitor to get to the same point. From that information, a captain can estimate how well his or her boat might finish a leg of the race compared to how long another boat will take to finish the same leg.

Absolute standings are an indication of where the boat currently stands in relation to the other boats in the class at a given point in the course. Prior to the start of the race, the system is programmed with any number of stages for the race. The stages are delineated by a starting check point and an ending check point. These stages are interspersed along the course and are used to measure the arrival time of a boat as it finishes each stage. For example, in a race of 300 miles, the arbitrary check points may be placed every 50 miles. A check point may be collocated with an official check point or “turn”.

Whenever a vehicle or competitor completes a stage, the communication device or SRT records the time and sends a SBD packet to the CMS 36. The CMS 36 compares the “distance made course,” adjusts for handicaps, and computes a place or standing for each competitor finishing a stage. The system produces updated reports and distributes outbound SBD packets for each SRT. Internet viewers can also access the information online.

### SUMMARY

The event or object monitoring and tracking system or satellite race telemetry (SRT) system of the present invention relies on communication protocols to provide logistical support for desert or off-road or open-water or air racing teams while minimizing the cost of satellite communications. By giving race teams bi-directional, geo-positional information in remote areas that are devoid of traditional communications infrastructure, teams are able to communicate essential position information reliably. In addition, SRT system 100 piggybacks or combines additional vehicle telemetry data onto position fixes that help a race team make effective tactical decisions during the race.

The satellite race telemetry system of the present invention thus provides location and vehicle telemetry data or information from the race vehicle 40 to the chase vehicles 41, 42. The race vehicle SRT unit 1 may communicate or stream a variety of data, such as latitude, longitude, time, speed, and heading information and/or the like, and may output or communicate such data at given time periods, such as, for example, every thirty seconds or thereabouts (or at longer or shorter time intervals as may be desired depending on the particular application of the SRT system), through the satellite constellation 31 to the satellite gateway 32. The satellite gateway 32 then sends the information packet 10 through the Internet 33 and onto the server 36, which logs and collates the data, and retransmits at least some of the data back along the same route to the team chase vehicles 41, 42. The chase vehicle SRTs 20 receive this information and then use BLUETOOTH® or wi-fi or other short range communication protocol to transmit the information to the display or PDA 38 of that vehicle, where it is accessible to the chase vehicle driver or occupants. With this information, chase crews can make intelligent decisions about how and where to intercept the race vehicle 40 during the race. Whether the race vehicle 40 is indeed moving, or whether the race vehicle has already passed a particular point, is thus substantially immediately made known to the occupants of the chase vehicles 40, 42.

The SRT system of the present invention thus may also provide a programmable interval for sending data to the SRT system web server by way of a satellite (this enhances or optimizes battery power and satellite airtime charges). The SRT system also allows race vehicles 40 and chase vehicles 41, 42 to send telemetry data to the servers 36. The SRT system may convert GPS data to a manageable transmittable data packet 10 that can be sent by way of satellite modem. The SRT system 100 also allows a chase vehicle to send an impromptu waypoint to the race vehicle 40, and allows the SRT to send downloaded waypoints to the race vehicle's primary GPS unit, such as by way of the NMEA 0183 port of the SRT unit.

Although shown and described for use in an off-road or desert or open-water (e.g. sailboat) racing event, it is envisioned that the SRT system of the present invention is suited for other applications. For example, the SRT system of the present invention may be implemented for other types of races where the race vehicle is out of sight or not readily accessible for long periods of times, such as air races or dogsled races or mountain climbing expeditions and/or the like. In such applications, the SRT system 100 may communicate data about the involved vehicles and/or individuals and may communicate waypoints to the team members in a similar manner as described above.

Optionally, for example, the SRT system of the present invention may be used to monitor and track individuals, and/or equipment instead of vehicles. For example, the SRT system may be used to track teams or individuals in a wilderness setting, where the SRT system may determine the location of the team or individual and may communicate a waypoint to the team or individual to direct them to a pickup location or rendezvous location or the like. Optionally, for example, the SRT system may be used to track rescue teams or firefighters or the like, such as firefighting teams that enter forest fires and the like. In such an application, the SRT system may track the teams or individuals and may communicate a waypoint to the team or individuals to direct them to a safe area or to a target area or a pickup location or rendezvous location or the like. For applications where the SRT system tracks and monitors individuals, particularly in dangerous situations, the SRT system may collect and communicate biometric data (such as heart rate, blood pressure, respirations, temperature and the like) of the involved individuals, and may communicate escape waypoints or rescue waypoints to the individuals if a concern arises as to the health or safety of the individuals.

The SRT system may be used to monitor and track multiple vehicles or individuals for the purpose of monitoring and verifying competitors' status and performance during racing events. In the case of off-road racing, the SRT system may be used to verify competing vehicles have arrived at specific check points and that they have negotiated the entire course. The SRT system may provide data useful for statistical analysis of the racing event. Data collected by the system is collected at a central monitoring station where it can be disseminated in various forms. As previously mentioned, the SRT system sends relevant information to units in the field. Additionally, the system is capable of generating various statistics such as split times and other descriptive statistics.

Other applications for the SRT system of the present invention may be contemplated and implemented while remaining within the spirit and scope of the present invention. Changes and modifications to the specifically described embodiments may be carried out without departing from the principles of the present invention, which is intended to be limited only by the scope of the appended claims as interpreted according to the principles of patent law including the doctrine of equivalents.

### LIST OF SYSTEM COMPONENTS

1. Race vehicle SRT
2. Satellite antenna (internal)
3. GPS antenna (internal)
4. Satellite module (modern)
5. GPS module
6. Backup battery
7. Dual UART
8. Dual UART
9. NMEA 0183 Port (GPS)
10. Packet data
11. Status indicator (LED)
12. BLUETOOTH® or Communications Module
13. Microprocessor
14. Flash memory
15. CAN bus (Automotive communications)
16. USB (Universal Serial Bus)
17. Voltage regulator control
18. 32 KHz Oscillator
19. 7.32 MHz Oscillator
20. Chase vehicle SRT
21. 3-axis accelerometer
22. Voltage regulator
23. Voltage regulator
24. Voltage regulator
25. Voltage regulator
26. Voltage regulator
27. Switching pre regulator
28. 12 Volt input
29. GPS satellite constellation
30. Communications pathway
31. Communications satellite constellation
32. Satellite gateway
33. Internet
34. PC
35. Antenna printed circuit board
36. Servers
37. Primary GPS (External)
38. Display screen (PDA, handheld computer, tablet PC)
39. SRT printed circuit board
40. Race vehicle
41. Ground chase vehicle
42. Chase helicopter
43. View definition table
44. View assignment table
45. Current vehicle data
46. Packet collation (process)
47. Team administrator
48. One dimensional boundary
49. Two dimensional boundaries (a, b, c)
50. Three dimensional boundaries (a, b, c)
51. Race course (land based)
52. Maimed check points (land based)
53. Highways
54. Automatic check points
55. Vessels (e.g., sailing)
56. Race course (point-to-point, open water)
57. Race course (closed course, open water)
58. Check point (open water)
59. Point
60. Shoal
61. Lighthouse
62. Concentric rings around lighthouse check point
63. Concentric rings around point check point
64. Concentric rings around check point
65. Concentric rings around shoal check point
66. Concentric rings around finish line
67. Finish line
68. Start line
100. Satellite Race Telemetry (SRT) System

1. A race tracking and monitoring system comprising:
at least one race vehicle communication device operable to generate at least one first output to a satellite network and to receive at least one input from the satellite network, said at least one race vehicle communication device being associated with a respective race vehicle, said first output including data indicative of a geographical location of the respective race vehicle;
at least one check point communication to the satellite network, said at least one check point communication including data indicative of a race vehicle passing a check point along the race route;
a control operable to receive said at least one first output of said at least one race vehicle communication device via the satellite network and to process said at least one first output, said control operable to receive said at least one check point communication via the satellite network and to process said at least one check point communication; and
wherein said control is operable to generate a control output responsive to said processing, said control output communicating data indicative of the geographical location of the race vehicle and its location along the race route to at least one remote communication device.

2. The race tracking and monitoring system of claim 1, wherein said control output communicates data to said at least one remote communication device via the satellite network.

3. The race tracking and monitoring system of claim 2, wherein said at least one remote communication device comprises at least one display operable to display said data of said control output.

4. The race tracking and monitoring system of claim 1, wherein said at least one race vehicle communication device comprises a plurality of race vehicle communication devices associated with respective ones of a plurality of race vehicles.

5. The race tracking and monitoring system of claim 4, wherein said control output communicates data indicative of the geographical locations of the race vehicles and their respective locations along the race route to said at least one remote communication device.

6. The race tracking and monitoring system of claim 1, wherein said at least one check point communication is generated by a check point communication device at a check point, said check point communication device being responsive to a sensing device at the respective check point, said sensing device being operable to sense and identify a race vehicle as it passes the respective check point.

7. The race tracking and monitoring system of claim 1, wherein said control determines at least one of (i) a standing of the race vehicle in the race, (ii) a split time for the race vehicle, (iii) a position of the race vehicle on a race course, (iv) the race vehicle's passage of a waypoint, and (v) a race time adjusted for a handicap of the race vehicle.

8. An event tracking system for tracking and monitoring multiple objects of an event, said event tracking system comprising:
a first communication device operable to generate a first output to a satellite network and to receive an input from the satellite network, said first communication device being associated with a first object, said first output including data indicative of a geographical location of the first object;
a first display device associated with the first object and operable to display information indicative of a geographical location of the first object;
a second communication device operable to generate a second output to the satellite network and to receive an input from the satellite network, said second communication device being associated with a second object, said second output including data indicative of a geographical location of the second object;
a second display device associated with the second object and operable to display information indicative of a geographical location of the second object;
a control operable to receive said first and second outputs of said first and second communication devices via the satellite network and to process said first and second outputs;
said control operable to generate a control output responsive to said processing, said control output communicating data indicative of the geographical location of the first object to said second communication device and said control output communicating data indicative of the geographical location of the second object to said first communication device;
wherein said first display device is operable to display information indicative of the geographical location of the second object in response to said control output and wherein said second display device is operable to display information indicative of the geographical location of the first object in response to said control output.

9. The event tracking system of claim 8, wherein said first communication device is responsive to said control output, said first communication device being operable to adjust information being communicated by said first communication device in response to said control output.

10. The event tracking system of claim 8, wherein said first output of said first communication device includes status information data relating to a status of the first object.

11. The event tracking system of claim 8, wherein said event comprises a vehicle race and the first object comprises a race vehicle and the second object comprises at least one chase vehicle, said control output communicating data indicative of the geographical location of the race vehicle to said second communication device of the at least one chase vehicle.

12. The event tracking system of claim 11, wherein the at least one chase vehicle comprises multiple chase vehicles, each having a second communication device and a second display device, said control output including data indicative of the geographical location of the chase vehicles, said second display devices displaying information indicative of the geographical location of the chase vehicles in response to said second communication device.

13. The event tracking system of claim 8, wherein said second output includes a waypoint, said control output communicating said waypoint to said first communication device, said first communication device communicating said waypoint via said first display device.

14. The event tracking system of claim 8, wherein said control generates said control output at particular time intervals to reduce the data transmission to said communication devices via the satellite network.

15. The event tracking system of claim 8, wherein said event comprises tracking individuals, the tracked object comprising at least one tracked individual and the tracking object comprising at least one rescue team vehicle or member, and wherein said first output of said first communication device includes biometric data of the tracked individual.

16. The event tracking system of claim 8, wherein said control processes said first and second outputs and generates packets of data for communication to respective ones of the first and second objects.

17. The event tracking system of claim 16, wherein said control combines multiple packets of data for communicating as a single packet to reduce the number of communications.

18. The event tracking system of claim 17, wherein said control prioritizes said packets and determines a transmission order of said packets.

19. The event tracking system of claim 8, wherein said first communication device is operable to adjust information being displayed by said first display device in response to said control output.

20. The event tracking system of claim 8, wherein said control output received by said first communication device may include different information or data than said control output received by said second communication device.

21. A method of tracking objects comprising:
providing a first communication device associated with a first object and a second communication device associated with a second object;
providing a first display device associated with the first object and operable to display information indicative of a geographical location of the first object;
providing a second display device associated with the second object and operable to display information indicative of a geographical location of the second object;
providing a control operable to receive first and second outputs of respective ones of the first and second communication devices via a satellite network and to process the first and second outputs, the first output including data indicative of a geographical location of the first object and the second output including data indicative of a geographical location of the second object;
generating a control output responsive to said processing, the control output communicating data indicative of the geographical location of the first object to the second communication device via the satellite network and the control output communicating data indicative of the geographical location of the second object to the first communication device via the satellite network;
displaying information indicative of the geographical location of the first object via the second display device and in response to the control output; and
displaying information indicative of the geographical location of the second object via the first display device and in response to the control output.

22. The method of claim 21, wherein the first communication device is responsive to the control output, the first communication device being operable to at least one of (a) adjust information being communicated by the first communication device in response to the control output, and (b) adjust information being displayed by the first display device in response to the control output.

23. The method of claim 22, wherein the first object comprises a first race vehicle and the second object comprises a second race vehicle, said method further comprising:
generating at least one check point communication to the satellite network, the at least one check point communication including data indicative of at least one of (a) the first race vehicle passing a check point along a race route, and (b) the second race vehicle passing a check point along a race route;
receiving the check point communication at the control via the satellite network; and
processing the check point communication at the control and communicating a control output indicative of the check point communication to a remote communication device.

24. The method of claim 23, wherein the first object comprises a race vehicle and the second object comprises a tracking vehicle.

25. The method of claim 23, further comprising adjusting information being displayed by the first display device in response to the control output.
